(19) United States
(12) Patent Application Publication
(10) Pub. No.: US 2024/0422761 A1
(43) Pub. Date: Dec. 19, 2024

(54) INFORMATION TRANSMISSION METHOD AND TERMINAL DEVICE

(71) Applicant: GUANGDONG OPPO MOBILE TELECOMMUNICATIONS CORP., LTD., Dongguan (CN)

(72) Inventors: Zhe LIU, Dongguan (CN); Zhihua SHI, Dongguan (CN); Jianfei CAO, Dongguan (CN); Yun FANG, Dongguan (CN)

(21) Appl. No.: 18/820,512

(22) Filed: Aug. 30, 2024

Related U.S. Application Data
(63) Continuation of application No. PCT/CN2022/082052, filed on Mar. 21, 2022.

(51) Int. Cl. H04W 72/044; H04B 7/06; H04W 72/1268

(52) U.S. Cl. CPC H04W 72/046; H04B 7/06956; H04W 72/1268

(57) ABSTRACT

An information transmission method includes: determining, based on at least one piece of spatial information associated with at least one group of uplink information, at least one first transmission parameter set used by the at least one group of uplink information; and transmitting, based on the at least one first transmission parameter set, the at least one group of uplink information to the network device.

### CROSS-REFERENCE TO RELATED APPLICATION

This application is a Continuation Application of International Application No. PCT/CN2022/082052 filed Mar. 21, 2022, which is incorporated herein by reference in its entirety.

### TECHNICAL FIELD

Embodiments of the present disclosure relate to the field of communications, and in particular, to an information transmission method, a terminal device, and a network device.

### BACKGROUND

In the New Radio (New Radio, NR) system, for a terminal device configured with a plurality of antenna panels and supporting simultaneous transmission of a physical uplink shared channel (Physical Uplink Shared Channel, PUSCH) on the plurality of antenna panels, the terminal device can simultaneously transmit PUSCH on a plurality of antenna panels in a manner such as frequency division multiplexing (frequency division multiplexing, FDM) or spatial division multiplexing (Spatial Division Multiplexing, SDM). For example, PUSCHs transmitted on different antenna panels may be aligned with corresponding transmission reception points (Transmission Reception Point, TRP) for simulated beamforming, thereby distinguishing PUSCHs transmitted to different TRPs in spatial domain.

Typically, a network device indicates a transmission parameter of a PUSCH transmitted to two TRPs, such as a beam direction of the PUSCH transmitted to the two TRPs, through a sounding reference signal (Sounding Reference Signal, SRS) resource set associated with the PUSCH and a sounding reference signal resource indicator (Sounding Reference Signal Resource Indicator, SRI) corresponding to each SRS resource set. However, for uplink information of different antenna panels, characteristics of corresponding transmission environment may also change. Therefore, how to determine a transmission parameter of uplink information on each antenna panel based on a change in transmission environment is a technical problem that needs to be urgently solved in this field.

### SUMMARY

In a first aspect, the present disclosure provides an information transmission method, including:

determining, based on at least one piece of spatial information associated with at least one group of uplink information, at least one first transmission parameter set used by the at least one group of uplink information; and sending, based on the at least one first transmission parameter set, the at least one group of uplink information to a network device.

In a second aspect, the present disclosure provides an information transmission method, including:
determining, based on the at least one piece of spatial information associated with at least one group of uplink information, the at least one first transmission parameter set used by the at least one group of uplink information; and receiving, based on the at least one first transmission parameter set, the at least one group of uplink information sent from a terminal device.

In a third aspect, the present disclosure provides a terminal device to perform the methods in the above-mentioned first aspect or various implementations thereof. Specifically, the terminal device includes a functional module for performing the methods in the above-mentioned first aspect or various implementations thereof.

In an implementation, the terminal device may include a processing unit, where the processing unit is configured to perform a function related to information processing. For example, the processing unit may be a processor.

In an implementation, the terminal device may include a sending unit and/or a receiving unit. The sending unit is configured to perform a function related to transmission, and the receiving unit is configured to perform a function related to reception. For example, the sending unit may be a transmitter or an emitter, and the receiving unit may be a receiver or a receiving device. For another example, the terminal device is a communication chip, the receiving unit may be an input circuit or an interface of the communication chip, and the sending unit may be an output circuit or an interface of the communication chip.

In a fourth aspect, the present disclosure provides a network device to perform the methods in the above-mentioned second aspect or various implementations thereof. Specifically, the network device includes a functional module for performing the methods in the above-mentioned second aspect or various implementations thereof.

In an implementation, the network device may include a processing unit, the processing unit is configured to perform a function related to information processing. For example, the processing unit may be a processor.

In an implementation, the network device may include a sending unit and/or a receiving unit. The sending unit is configured to perform a function related to transmission, and the receiving unit is configured to perform a function related to reception. For example, the sending unit may be a transmitter or an emitter, and the receiving unit may be a receiver or a receiving device. For another example, the network device is a communication chip, the receiving unit may be an input circuit or an interface of the communication chip, and the sending unit may be an output circuit or an interface of the communication chip.

In a fifth aspect, the present disclosure provides a terminal device, including a processor and a memory. The memory is configured to store a computer program, and the processor is configured to call and run the computer program stored in the memory to perform the methods in the above-mentioned first aspect or various implementations thereof.

In an implementation, the processor is one or more, and the memory is one or more.

In an implementation, the memory may be integrated with the processor, or the memory may be disposed separately from the processor.

In an implementation, the terminal device further includes a transmitter (emitter) and a receiver (receiving device).

In a sixth aspect, the present disclosure provides a network device, including a processor and a memory. The memory is configured to store a computer program, and the processor is configured to call and run the computer program stored in the memory to perform the methods in the above-mentioned second aspect or various implementations thereof.

In an implementation, the processor is one or more, and the memory is one or more.

In an implementation, the memory may be integrated with the processor, or the memory may be disposed separately from the processor.

In an implementation, the network device further includes a transmitter (emitter) and a receiver (receiving device).

In a seventh aspect, the present disclosure provides a chip for implementing the methods in any one of the above-mentioned first to second aspects or various implementation thereof. Specifically, the chip includes: a processor, configured to call a computer program from a memory and run the computer program, so as to enable a device equipped with the chip to perform the method of any one of the above-mentioned first to second aspects or various implementations thereof.

In an eighth aspect, the present disclosure provides a non-transitory computer-readable storage medium to store a computer program, and the computer program enables the computer to perform the method of any one of the above-mentioned first to second aspects or various implementations thereof.

In a ninth aspect, the present disclosure provides a computer program product, including computer program instructions, the computer program instructions enable a computer to perform the method of any one of the above-mentioned first to second aspects above or various implementations thereof.

In a tenth aspect, the present disclosure provides a computer program, the computer program, upon being executed on a computer, enables the computer to perform the method of any one of the above-mentioned first to second aspects or various implementations thereof.

### BRIEF DESCRIPTION OF THE DRAWINGS

FIG. 1 is an example of a 5G communication system provided in the embodiments of the present disclosure.

FIG. 2 is another example of a 5G communication system provided in the embodiments of the present disclosure.

FIG. 3 is a schematic flowchart of an information transmission method provided in the embodiments of the present disclosure.

FIG. 4A is a schematic diagram of a relationship between at least one piece of spatial information and at least one group of uplink information provided in the embodiments of the present disclosure.

FIG. 4B is another schematic diagram of a relationship between at least one piece of spatial information and at least one group of uplink information provided in the embodiments of the present disclosure.

FIG. 5 is a schematic diagram of an association relationship between at least one second transmission parameter set and at least one third transmission parameter set provided in the embodiments of the present disclosure.

FIG. 6 is a schematic diagram of a timing relationship between first information and at least one group of uplink information provided in the embodiments of the present disclosure.

FIG. 7A is an example diagram of a MAC (media access control) CE (control element) carrying first information provided in the embodiments of the present disclosure.

FIG. 7B is another example diagram of a MAC CE carrying first information provided in the embodiments of the present disclosure.

FIG. 8 is an example of a determination manner of at least one first transmission parameter set data transmission method provided in the embodiments of the present disclosure.

FIG. 9 is another schematic flowchart of an information transmission method provided in the embodiments of the present disclosure.

FIG. 10 is a schematic block diagram of a terminal device provided in the embodiments of the present disclosure.

FIG. 11 is a schematic block diagram of a network device provided in the embodiments of the present disclosure.

FIG. 12 is a schematic block diagram of a communication device provided in the embodiments of the present disclosure.

FIG. 13 is a schematic block diagram of a chip of the embodiments provided in the present disclosure.

### DETTAILED DESCRIPTION

Technical solutions in the embodiments of the present disclosure will be described blew with reference to the accompanying drawings.

The embodiments of the present provide an information transmission method, which is applicable to a terminal device. The method includes:
determining, based on at least one piece of spatial information associated with at least one group of uplink information, at least one first transmission parameter set used by the at least one group of uplink information; and
sending, based on the at least one first transmission parameter set, the at least one group of uplink information to a network device.

In some embodiments, the at least one group of uplink information is associated with at least one transmission reception point (TRP), or the at least one group of uplink information is associated with at least one antenna panel, or the at least one group of uplink information is associated with at least one uplink transmission spatial filter.

In some embodiments, each group of uplink information in the at least one group of uplink information includes one or more pieces of uplink information, and the each group of uplink information in the at least one group of uplink information is associated with a same piece of spatial information in the at least one piece of spatial information.

In some embodiments, the same piece of spatial information includes at least one of the following information: transmission configuration indication (TCI) state information, antenna panel information, transmission reception point (TRP) information, control resource set (CORESET) group information, reference signal set information, beam information, or capability set information.

In some embodiments, the determining, based on the at least one piece of spatial information associated with the at least one group of uplink information, the at least one first transmission parameter set used by the at least one group of uplink information includes:
determining at least one second transmission parameter set associated with the at least one piece of spatial information as the at least one first transmission parameter set.

In some embodiments, the second transmission parameter set includes at least one of the following information: an uplink transmission spatial filter of uplink information, power control parameter information of uplink information, beam information of uplink information, precoding information of uplink information, information of a number of transmission layers of uplink information, sounding reference signal (SRS) resource set information associated with uplink information, sounding reference signal resource indicator (SRI) information associated with uplink information, demodulation reference signal (DMRS) port information of uplink information, or transmission port information used by an SRS resource indicated by the SRI.

In some embodiments, the DMRS port information of the uplink information is DMRS port information used by the uplink information associated with the SRS resource set, and/or the transmission port information used by the SRS resource indicated by the SRI is transmission port information used by the uplink information associated with the SRS resource set.

In some embodiments, the determining, based on the at least one piece of spatial information associated with the at least one group of uplink information, the at least one first transmission parameter set used by the at least one group of uplink information includes:
determining at least one second transmission parameter set associated with the at least one piece of spatial information; and
determining at least one third transmission parameter set associated with the at least one second transmission parameter set as the at least one first transmission parameter set.

In some embodiments, the second transmission parameter set includes sounding reference signal (SRS) resource set information.

In some embodiments, the third transmission parameter set includes at least one of: precoding information used by uplink information, information of a number of transmission layers used by uplink information, sounding reference signal resource indicator (SRI) information associated with uplink information, demodulation reference signal (DMRS) port information used by uplink information, or transmission port information used by uplink information.

In some embodiments, first transmission parameter set used by each group of uplink information in the at least one group of uplink information further includes at least one of the following items associated with spatial information associated with the each group of uplink information: uplink transmission spatial filter used by uplink information, power control parameter information used by uplink information, or beam information used by uplink information.

In some embodiments, the method further includes:
receiving first information sent from the network device, where the first information includes at least one of: an association relationship between the at least one piece of spatial information and the at least one second transmission parameter set, or an association relationship between the at least one piece of spatial information and at least one uplink resource set where the at least one group of uplink information is located.

In some embodiments, the first information further includes at least one of: an association relationship between the at least one piece of spatial information and the at least one group of uplink information, or an association relationship between the at least one second transmission parameter set and the at least one first transmission parameter set.

In some embodiments, the at least one uplink resource set includes a first uplink resource set and a second uplink resource set; where an index of a resource unit in the first uplink resource set is less than an index of a resource unit in the second uplink resource set; or an index of a resource unit in the first uplink resource set is an even number and an index of a resource unit in the second uplink resource set is an odd number.

In some embodiments, the first information is carried in downlink control information (DCI), a radio resource control (RRC) signaling or a media access control (MAC) control element (CE).

In some embodiments, the first information is carried in the DCI; and the at least one piece of spatial information includes first spatial information; where the first information is used to indicate any one of the following:
the first spatial information being associated with a first group of uplink information in the at least one group of uplink information, the first spatial information being associated with a first second transmission parameter set of the at least one second transmission parameter set, the first spatial information being associated with a second group of uplink information in the at least one group of uplink information, and the first spatial information being associated with a second second transmission parameter set in the at least one second transmission parameter set.

In some embodiments, the first information is carried in the DCI; the at least one piece of spatial information includes first spatial information and second spatial information; where the first information is used to indicate:
the first spatial information being associated with a first group of uplink information in the at least one group of uplink information or a first second transmission parameter set in the at least one second transmission parameter set, and the second spatial information being associated with a second group of uplink information in the at least one group of uplink information or a second second transmission parameter set in the at least one second transmission parameter set; and
the first spatial information being associated with the second group of uplink information or the second second transmission parameter set, and the second spatial information being associated with the first group of uplink information or the first second transmission parameter set.

In some embodiments, the first information is carried in the DCI; the at least one piece of spatial information includes first spatial information and second spatial information; where the first information is used to indicate any one of the following:
the first spatial information being associated with a first group of uplink information in the at least one group of uplink information, or the first spatial information being associated with a first second transmission parameter set in the at least one second transmission parameter set;
the first spatial information being associated with a second group of uplink information in the at least one group of uplink information, or the first spatial information being associated with a second second transmission parameter set in the at least one second transmission parameter set;
the first spatial information being associated with the first group of uplink information or the first second transmission parameter set, and the second spatial information being associated with the second group of uplink information or the second second transmission parameter set; and
the first spatial information being associated with the second group of uplink information or the second second transmission parameter set, and the second spatial information being associated with the first group of uplink information or the first second transmission parameter set.

In some embodiments, the first information is carried in the RRC signaling or the MAC CE; and each sounding reference signal (SRS) resource or SRS resource set configured by the RRC signaling or the MAC CE is associated with one piece of spatial information of the at least one piece of spatial information.

In some embodiments, the MAC CE includes at least one of: an identification of a serving cell, an identification of a bandwidth part (BWP), an identification of the at least one piece of spatial information, an index of a sounding reference signal (SRS) resource associated with each spatial information of the at least one piece of spatial information, or an index of an SRS resource set associated with the each spatial information.

In some embodiments, the method further includes:
determining a determining manner of the at least one first transmission parameter set;
where the determining manner of the at least one first transmission parameter includes a first determining manner and a second determining manner, the first determining manner refers to determining the at least one first transmission parameter set based on at least one second transmission parameter set associated with the at least one piece of spatial information, and the second determining manner refers to determining the at least one first transmission parameter set based on a reference signal associated with a sounding reference signal (SRS) resource or an SRS resource set associated with the at least one group of uplink information.

In some embodiments, the determining the determining manner of the at least one first transmission parameter set includes:
determining the first determining manner or the second determining manner as the determining manner of the at least one first transmission parameter set.

In some embodiments, the determining the first determining manner or the second determining manner as the determining manner of the at least one first transmission parameter set includes:
in a case where a first condition is met, determining the first determining manner as the determining manner of the at least one first transmission parameter set; or
in a case where the first condition is not met, determining the second determining manner as the determining manner of the at least one first transmission parameter set;
where the first condition refers to that a first time interval is greater than or equal to a first duration; where the first time interval is an interval between a first time unit and a second time unit, the first time unit is a time unit where an ending location of an uplink control channel carrying feedback information of the at least one piece of spatial information is located, and the second time unit is a time unit where a starting location of a physical channel carrying the at least one group of uplink information is located.

In some embodiments, the determining the determining manner of the at least one first transmission parameter set includes:
receiving second information sent from the network device, where the second information is used to indicate the determining manner of the at least one first transmission parameter set.

In some embodiments, the at least one group of uplink information is scheduled by a same piece of downlink control information (DCI).

In some embodiments, each spatial information of the at least one piece of spatial information includes at least one of the following information: transmission configuration indication (TCI) state information, antenna panel information, transmission reception point (TRP) information, control resource set (CORESET) group information, reference signal set information, beam information, or capability set information.

In some embodiments, each group of uplink information in the at least one group of uplink information includes at least one of: at least one physical uplink control channel (PUCCH), at least one physical uplink shared channel (PUSCH), a PUCCH corresponding to at least one transmission layer, a PUSCH corresponding to at least one transmission layer, a PUSCH corresponding to at least one redundant version (RV), at least one transmission block, at least one piece of uplink information transmitted in a frequency division multiplexing (FDM) transmission mode, at least one piece of uplink information transmitted in a spatial domain multiplexing (SDM) transmission mode, a PUSCH associated with at least one antenna panel, or a PUCCH associated with at least one antenna panel.

The embodiments of the present disclosure further provide an information transmission method, which is applicable to a network device and includes:
determining, based on at least one piece of spatial information used by at least one group of uplink information, at least one first transmission parameter set used by the at least one group of uplink information; and
receiving, based on the at least one first transmission parameter set, the at least one group of uplink information sent from a terminal device.

In some embodiments, the at least one group of uplink information is associated with at least one transmission reception point (TRP), or the at least one group of uplink information is associated with at least one antenna panel, or the at least one group of uplink information is associated with at least one uplink transmission spatial filter.

In some embodiments, each group of uplink information in the at least one group of uplink information includes one or more pieces of uplink information, and the each group of uplink information in the at least one group of uplink information is associated with a same piece of spatial information in the at least one piece of spatial information.

In some embodiments, the same piece of spatial information includes at least one of the following information: transmission configuration indication (TCI) state information, antenna panel information, transmission reception point (TRP) information, control resource set (CORESET) group information, reference signal set information, beam information, or capability set information.

In some embodiments, the determining, based on the at least one piece of spatial information associated with the at least one group of uplink information, the at least one first transmission parameter set used by the at least one group of uplink information, includes:
determining at least one second transmission parameter set associated with the at least one piece of spatial information as the at least one first transmission parameter set.

In some embodiments, the second transmission parameter set includes at least one of the following information: an uplink transmission spatial filter of uplink information, power control parameter information of uplink information, beam information of uplink information, precoding information of uplink information, information of a number of transmission layers of uplink information, sounding reference signal (SRS) resource set information associated with uplink information, sounding reference signal resource indicator (SRI) information associated with uplink information, demodulation reference signal (DMRS) port information of uplink information, or transmission port information used by an SRS resource indicated by the SRI.

In some embodiments, the DMRS port information of the uplink information is DMRS port information used by the uplink information associated with the SRS resource set, and/or the transmission port information used by the SRS resource indicated by the SRI is transmission port information used by the uplink information associated with the SRS resource set.

In some embodiments, the determining, based on the at least one piece of spatial information associated with the at least one group of uplink information, the at least one first transmission parameter set used by the at least one group of uplink information includes, includes:
determining at least one second transmission parameter set associated with the at least one piece of spatial information; and
determining at least one third transmission parameter set associated with the at least one second transmission parameter set as the at least one first transmission parameter set.

In some embodiments, the second transmission parameter set includes sounding reference signal (SRS) resource set information.

In some embodiments, the third transmission parameter set includes at least one of: precoding information used by uplink information, information of a number of transmission layers used by uplink information, sounding reference signal resource indicator (SRI) information associated with uplink information, demodulation reference signal (DMRS) port information used by uplink information, or transmission port information used by uplink information.

In some embodiments, the first transmission parameter set used by the each group of uplink information in the at least one group of uplink information further includes at least one of the following items associated with spatial information associated with the each group of uplink information: an uplink transmission spatial filter used by uplink information, power control parameter information used by uplink information, or beam information used by uplink information.

In some embodiments, the method further includes:
sending first information to the terminal device, where the first information includes at least one of: an association relationship between the at least one piece of spatial information and the at least one second transmission parameter set, or an association relationship between the at least one piece of spatial information and at least one uplink resource set where the at least one group of uplink information is located.

In some embodiments, the first information further includes at least one of: an association relationship between the at least one piece of spatial information and the at least one group of uplink information, or an association relationship between the at least one second transmission parameter set and the at least one first transmission parameter set.

In some embodiments, the at least one uplink resource set includes a first uplink resource set and a second uplink resource set; where an index of a resource unit in the first uplink resource set is less than an index of a resource unit in the second uplink resource set; or an index of a resource unit in the first uplink resource set is an even number and an index of a resource unit in the second uplink resource set is an odd number.

In some embodiments, the first information is carried in downlink control information (DCI), a radio resource control (RRC) signaling or a media access control (MAC) control element (CE).

In some embodiments, the first information is carried in the DCI; and the at least one piece of spatial information includes first spatial information; where the first information is used to indicate any one of the following:
the first spatial information being associated with a first group of uplink information in the at least one group of uplink information, the first spatial information being associated with a first second transmission parameter set in the at least one second transmission parameter set, the first spatial information being associated with a second group of uplink information in the at least one group of uplink information, and the first spatial information associated with a second second transmission parameter set in the at least one second transmission parameter set.

In some embodiments, the first information is carried in the DCI; and the at least one piece of spatial information includes first spatial information and second spatial information; where the first information is used to indicate:
the first spatial information being associated with a first group of uplink information in the at least one group of uplink information or a first second transmission parameter set in the at least one second transmission parameter set, and the second spatial information being associated with a second group of uplink information in the at least one group of uplink information or a second second transmission parameter set in the at least one second transmission parameter set;
the first spatial information being associated with the second group of uplink information or the second second transmission parameter set, and the second spatial information being associated with the first group of uplink information or the first second transmission parameter set.

In some embodiments, the first information is carried in the DCI; and the at least one piece of spatial information comprises first spatial information and second spatial information; where the first information is used to indicate any one of the following;
the first spatial information being associated with a first group of uplink information in the at least one group of uplink information, or the first spatial information being associated with a first second transmission parameter set in the at least one second transmission parameter set;
the first spatial information being associated with a second group of uplink information in the at least one group of uplink information, or the first spatial information being associated with a second second transmission parameter set in the at least one second transmission parameter set;
the first spatial information being associated with the first group of uplink information or the first second transmission parameter set, and the second spatial information being associated with the second group of uplink information or the second second transmission parameter set; and
the first spatial information being associated with the second group of uplink information or the second second transmission parameter set, and the second spatial information being associated with the first group of uplink information or the first second transmission parameter set.

In some embodiments, the first information is carried in the RRC signaling or the MAC CE; and each sounding reference signal (SRS) resource or SRS resource set configured by the RRC signaling or the MAC CE is associated with one piece of spatial information of the at least one piece of spatial information.

In some embodiments, the MAC CE includes at least one of: an identification of a serving cell, an identification of a bandwidth part (BWP), an identification of the at least one piece of spatial information, an index of a sounding reference signal (SRS) resource associated with each spatial information in the at least one piece of spatial information, or an index of an SRS resource set associated with the each spatial information.

In some embodiments, the method further includes:
determining a determining manner of the at least one first transmission parameter set;
where the determining manner of the at least one first transmission parameter includes a first determining manner and a second determining manner, the first determining manner refers to determining the at least one first transmission parameter set based on the at least one second transmission parameter set associated with the at least one piece of spatial information, and the second determining manner refers to determining the at least one first transmission parameter set based on a reference signal associated with a sounding reference signal (SRS) resource or an SRS resource set associated with the at least one group of uplink information.

In some embodiments, the determining the determining manner of the at least one first transmission parameter set includes:
determining the first determining manner or the second determining manner as the determining manner of the at least one first transmission parameter set.

In some embodiments, the determining the first determining manner or the second determining manner as the determining manner of the at least one first transmission parameter set includes:
in a case where a first condition is met, determining the first determining manner as the determining manner of the at least one first transmission parameter set; or
in a case where the first condition is not met, determining the second determining manner as the determining manner of the at least one first transmission parameter set;
where the first condition refers to that a first time interval is greater than or equal to a first duration; where the first time interval is an interval between a first time unit and a second time unit, the first time unit is a time unit where an ending location of an uplink control channel carrying feedback information of the at least one piece of spatial information is located, and the second time unit is a time unit where a starting location of a physical channel carrying the at least one group of uplink information is located.

In some embodiments, the determining the determining manner of the at least one first transmission parameter set includes:
sending second information to the terminal device, where the second information is used to indicate the determining manner of the at least one first transmission parameter set.

In some embodiments, the at least one group of uplink information is scheduled by a same piece of downlink control information (DCI).

In some embodiments, each spatial information of the at least one piece of spatial information includes at least one of the following information: transmission configuration indication (TCI) state information, antenna panel information, transmission reception point (TRP) information, control resource set (CORESET) group information, reference signal set information, beam information, or capability set information.

In some embodiments, each group of uplink information in the at least one group of uplink information includes at least one of: at least one physical uplink control channel (PUCCH), at least one physical uplink shared channel (PUSCH), a PUCCH corresponding to at least one transmission layer, a PUSCH corresponding to at least one transmission layer, a PUSCH corresponding to at least one redundant version (RV), at least one transmission block, at least one piece of uplink information transmitted in a frequency division multiplexing (FDM) transmission mode, at least one piece of uplink information transmitted in a spatial domain multiplexing (SDM) transmission mode, a PUSCH associated with the at least one antenna panel, or a PUCCH associated with the at least one antenna panel.

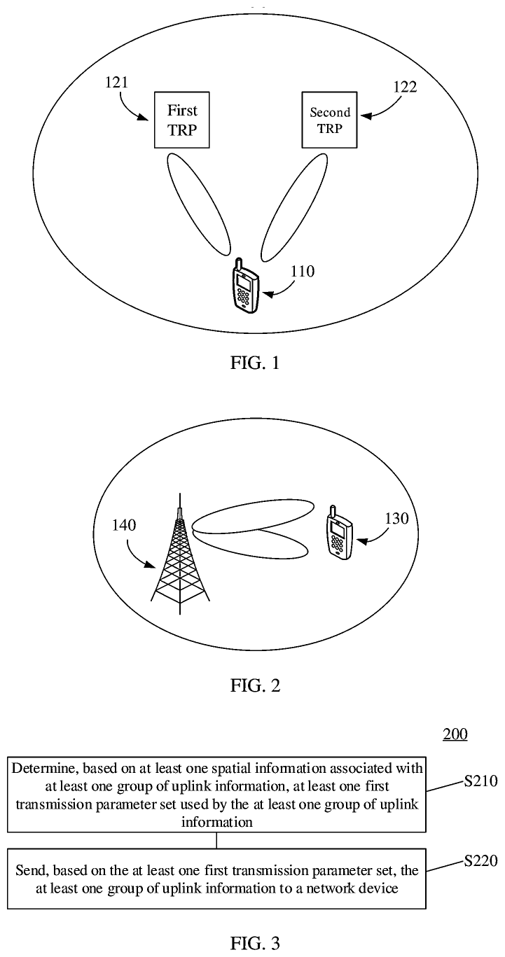

FIG. 1 is an example diagram of a 5G communication system 100 of the embodiments of the present disclosure.

As shown in FIG. 1, the communication system 100 may include a terminal device 110, a first transmission reception point (Transmission Reception Point, TRP) 121, and a second TRP 122. The first TRP 121 and the second TRP 122 may communicate with the terminal device 110 through an air interface respectively. Specifically, the first TRP 121 and the second TRP 122 may independently schedule the terminal device 110 for data transmission.

For example, the terminal device 110 detects PDCCHs from the first TRP 121 and the second TRP 122 respectively in a time slot, so as to schedule multiple independent uplink data transmissions, and these independent uplink transmissions may be scheduled in a same time slot.

However, in the communication system shown in FIG. 1, there may be multiple communication scenarios.

For example, the first TRP 121 and the second TRP 122 belong to a same cell, and a connection (backhaul) between the first TRP 121 and the second TRP 122 is ideal, that is, information interaction may be performed quickly and dynamically.

For another example, the first TRP 121 and the second TRP 122 belong to a same cell, and the backhaul between the first TRP 121 and the second TRP 122 is non-ideal, that is, the first TRP 121 and the second TRP 122 cannot exchange information quickly, and can only perform relatively slow data exchanging.

For another example, the first TRP 121 and the second TRP 122 belong to different cells, and the backhaul between the first TRP 121 and the second TRP 122 is ideal.

For another example, the first TRP 121 and the second TRP 122 belong to different cells, and the backhaul between the first TRP 121 and the second TRP 122 is non-ideal.

Since a network device may send different NR-PDCCH/NR-PDSCHs from multiple TRPs to a terminal device, that is, the terminal device receives downlink information through multiple downlinks, where each downlink has corresponding uplink information to be transmitted, and the uplink information includes at least one of the following signals: acknowledgment/non-acknowledgment (ACK/NACK) corresponding to each downlink, reporting information such as channel state information (CSI) corresponding to each downlink, and other, or uplink data.

It should be understood that the embodiments of the present disclosure are only illustrated by taking the 5G communication system 100 as an example, but the embodiments of the present disclosure are not limited thereto. That is to say, the technical solutions of the embodiments of the present disclosure may be applied to any communication system in which multiple network devices can independently schedule a terminal to transmit data. For example, the TRP in FIG. 1 corresponds to a beam, and then, an application scenario example as shown in FIG. 2 can be obtained correspondingly, where the scenario includes a terminal device 130 and a network device 140, where there are multiple beams between the terminal device 130 and the network device 140.

For example: global system of mobile communication (Global System of Mobile communication, GSM) system, code division multiple access (Code Division Multiple Access, CDMA) system, wideband code division multiple access (Wideband Code Division Multiple Access, WCDMA) system, general packet radio service (General Packet Radio Service, GPRS), long term evolution (Long Term Evolution, LTE) system, LTE time division duplex (Time Division Duplex, TDD), universal mobile telecommunication system (Universal Mobile Telecommunication System, UMTS), etc.

The present disclosure describes various embodiments in conjunction with a network device and a terminal device.

A network device 120 may refer to any entity on the network side and used to send or receive a signal. For example, the network device 120 may be a user equipment of machine type communication (MTC), a base transceiver station (Base Transceiver Station, BTS) in GSM or CDMA, a station (NodeB) in WCDMA, an Evolutional Node B (Evolutional Node B, eNB or eNodeB) in LTE, a base station device in a 5G network, etc.

Furthermore, the terminal device 110 may be any terminal device. Specifically, the terminal device 110 may communicate with one or more core networks (Core Network) through a radio access network (Radio Access Network, RAN), and may also be called an access terminal, a user equipment (User Equipment, UE), a user unit, a user station, a mobile station, a mobile station, a remote station, a remote terminal, a mobile device, a user terminal, a terminal, a wireless communication device, a user agent or a user apparatus. For example, the terminal device 110 may be a cellular phone, a cordless phone, a session initiation protocol (Session Initiation Protocol, SIP) phone, a wireless local loop (Wireless Local Loop, WLL) station, a personal digital processing (Personal Digital Assistant, PDA), a handheld device with wireless communication functions, a computing device or other processing device connected to a wireless modem, a vehicle-mounted device, a wearable device, and a terminal device in a 5G network, etc.

To facilitate the understanding of solutions of the present disclosure, the relevant technologies are described below.

1. Physical uplink shared channel (Physical Uplink Shared Channel, PUSCH) transmission solution based on multiple transmission reception points (Transmission Reception Point, TRP) in NR Release 17.

In the NR system, downlink and uplink non-coherent transmission based on multiple TRPs is introduced. Herein, the backhaul (backhaul) connection between TRPs may be ideal or non-ideal. Under an ideal backhaul connection, information may be exchanged between TRPs quickly and dynamically, so the latency is small. Under a non-ideal backhaul connection, information can be only exchanged between TRPs quasi-statically, so the latency is large. In downlink non-coherent transmission, multiple TRPs may adopt different control channels to independently schedule multiple PDSCH transmissions of a terminal, or adopt a same control channel to schedule transmissions of different TRPs. For example, in a case of an ideal backhaul connection, a same control channel may be adopted to schedule transmissions of different TRPs. Data of different TRPs may adopt different transport layers.

When a network device schedules, through a DCI (downlink control information), a terminal device to transmit PUSCHs to two TRPs, the PUSCHs transmitted to the two TRPs may be configured with independent transmission parameters, such as beams and precoding matrices, and the numbers of transmission layers of the PUSCHs transmitted to the two TRPs may be the same. In NR Release 17, PUSCHs transmitted to two TRPs may be transmitted in a time division multiplexing (Time Division Multiplexing, TDM) manner. The PUSCHs transmitted from the terminal device to different TRPs are aligned with the corresponding TRP for analog beamforming, that is, different PUSCHs may be distinguished by spatial domain to improve uplink spectrum efficiency.

For codebook-based PUSCH transmission, the DCI needs to include two sounding reference signal resource indicator (SRS resource indicator, SRI) fields and two precoding information and number of layers (Precoding information and number of layers) fields. Optionally, a network device may configure two sounding reference signal (Sounding Reference Signal, SRS) resource sets for a terminal device, where the first SRI field of the two SRI fields corresponds to the first SRS resource set of the two SRS resource sets, and a second SRI field of the two SRI fields corresponds to a second SRS resource set of the two SRS resource sets. The two SRIs may be used to indicate beam directions of the PUSCH transmitted to the two TRPs, respectively. The first precoding information and number of layers field in the two precoding information and number of layers fields are used to indicate the precoding information and number of layers of the PUSCH transmitted to the first TRP of the two TRPs. The second precoding information and number of layers field in the two precoding information and number of layers fields are used to indicate the precoding information of the PUSCH transmitted to the second TRP of the two TRPs. The number of layers of the PUSCH transmitted to the second TRP is the same as the number of layers indicated by the first precoding information and number of layers field by default.

For non-codebook based PUSCH transmission, the DCI needs to include two SRI fields, where the first SRI field is used to indicate the beam direction and the number of transmission layers of the PUSCH transmitted to the first TRP of the two TRPs, and the second SRI field is used to indicate the beam direction of the PUSCH transmitted to the second TRP of the two TRPs, and the number of transmission layers of the PUSCH transmitted to the second TRP of the two TRPs is the same as the number of transmission layers indicated by the first SRI. The beam direction of the PUSCH is the same as the beam direction of the SRS resource indicated by the SRI.

The network device may also schedule, through multiple DCIs, the terminal device to transmit a PUSCH to two TRPs, and the multiple DCIs may be carried by different CORESETs. Specifically, the network side configures multiple CORESET groups, and each TRP is scheduled using a CORESET in its own CORESET group, that is, different TRPs may be distinguished by the CORESET group. For example, the network device may configure a CORESET group index for each CORESET, and different indexes correspond to different TRPs.

2. NR Release 16 PDSCH transmission solution for multiple TRPs.

In NR Release 16, PDSCHs from two TRPs scheduled by s-DCI may be distinguished by a TCI state (TCI state). A state of the TCI information field in the DCI may be mapped to up to two TCI states, and each TCI state corresponds to an FDM/SDM transmitted PDSCH of the PDSCHs.

Due to different spatial locations of different TRPs, large-scale characteristics of channels corresponding to respective TRPs have obvious differences. Therefore, when multiple TRPs are transmitted jointly, QCL information corresponding to respective TRPs needs to be indicated, respectively. In R15, a state of the TCI information field in DCI corresponds to only one TCI state. In order to support transmission based on multiple TRPs, MAC-CE signaling is enhanced in R16, that is, a TCI state group in the TCI information field in the DCI may be mapped to a maximum of 2 TCI states. If a TCI state group indicated in the DCI indicates two TCI states, a PDSCH associated with the first TCI state will be transmitted using a DMRS port indicated in the first CDM group, and a PDSCH associated with the second TCI state will be transmitted using a DMRS port indicated in the second CDM group. The beam direction of PDSCH is the same as the beam direction of SSB or CSI-RS corresponding to the TCI state.

The configuration and indication of the TCI state include RRC (radio resource control) configuration, MAC-CE activation and DCI indication. The RRC configures a maximum of M TCI states for the terminal by PDSCH-Config, where the value of M is determined by the UE capability and the maximum value of M may be 128. The MAC-CE activates up to 8 TCI state groups for mapping to the 3-bit TCI information field in DCI. Each TCI state group activated by the MAC-CE may include 1 or 2 TCI states. If the higher layer parameter configuration DCI includes a TCI indication field, DCI format 1_1 can indicate a TCI state group from the TCI state groups activated by MAC-CE. If the higher layer parameter configuration DCI does not include the TCI indication field or data is scheduled through DCI format 1_0, the DCI will not include the TCI state indication field.

A TCI state may contain the following configurations:
TCI state ID, used to identify a TCI state;
QCL Information 1.

Optionally, the TCI state may also include QCL information 2.

A QCL information further contains the following information:
QCL type configuration, which may be one of QCL type A, QCL type B, QCL type C or QCL type D;
QCL reference signal configuration, which includes a cell ID where the reference signal is located, a band width part (Band Width Part, BWP) ID and a reference signal identifier; the reference signal identifier may be a channel state information reference signal (Channel State Information Reference Signal, CSI-RS) resource ID or a synchronization signal block (Synchronization Signal Block, SSB) index.

If QCL information 1 and QCL information 2 are configured, QCL type of at least one piece of QCL information must be one of QCL typeA, QCL typeB, and QCL typeC, and the QCL type of the other QCL information must be QCL typeD.

The definition of the QCL type configuration is as follows:
‘QCL-TypeA’: {doppler shift (Doppler shift), doppler spread (Doppler spread), average delay (average delay), delay spread (delay spread)};
‘QCL-TypeB’: {Doppler shift, Doppler spread};
‘QCL-TypeC’: {Doppler shift, average delay};
‘QCL-TypeD’: {spatial Rx parameter (Spatial Rx parameter)}.

From the above content, in the New Radio (New Radio, NR) system, for a terminal device configured with multiple antenna panels (panel) and supporting simultaneous transmission of the physical uplink shared channel (Physical Uplink Shared Channel, PUSCH) on multiple antenna panels, the terminal device can simultaneously transmit PUSCH on multiple antenna panels in a manner such as frequency division multiplexing (frequency division multiplexing, FDM) or spatial division multiplexing (Spatial Division Multiplexing, SDM). For example, PUSCHs transmitted on different antenna panels may be aligned with corresponding transmission reception points (TRPs) for simulated beamforming, thereby distinguishing PUSCHs transmitted to different TRPs in spatial domain.

Typically, a network device indicates transmission parameters of the PUSCHs transmitted to two TRPs, for example the beam direction of the PUSCH transmitted to the two TRPs, through the sounding resource signal (Sounding Reference Signal, SRS) resource set associated with the PUSCH and the sounding reference signal resource indicator (Sounding Reference Signal Resource Indicator, SRI) corresponding to each SRS resource set. However, for the uplink information of different antenna panels, characteristics of corresponding transmission environment may also change. Therefore, how to determine a transmission parameter of uplink information on each antenna panel based on a change in transmission environment is a technical problem that needs to be urgently solved in this field.

In view of this, the present disclosure provides an information transmission method, a terminal device, and a network device, which can determine a transmission parameter of uplink information on each antenna panel based on a change in transmission environment, thereby improving system performance.

FIG. 3 is a schematic flowchart of an information transmission method 200 provided in the embodiments of the present disclosure. The information transmission method 200 may be executed by a terminal device. For example, the terminal device may be the terminal device 110 shown in FIG. 1 or the terminal device 130 shown in FIG. 2.

As shown in FIG. 3, the method 200 may include:
S210, determining, by a terminal device, based on at least one piece of spatial information associated with at least one group of uplink information, at least one first transmission parameter set used by the at least one group of uplink information;
S220, sending, by the terminal device, based on the at least one first transmission parameter set, the at least one group of uplink information to a network device.

Exemplarily, each group of uplink information in the at least one group of uplink information is associated with a piece of spatial information in the at least one piece of spatial information. In other words, uplink information included in the same group of uplink information in the at least one piece of uplink information uses the same first transmission parameter set, or, different pieces of uplink information in the same group of uplink information use the same first transmission parameter set. Based on this, the terminal device may determine corresponding at least one first transmission parameter set based on spatial information associated with the group where the uplink information is located, and then send corresponding uplink information in the group to the network device based on the determined at least one first transmission parameter set.

In this embodiment, at least one piece of spatial information associated with at least one group of uplink information is introduced, and at least one first transmission parameter set used by the at least one group of uplink information is determined based on the at least one piece of spatial information; and then based on the at least one first transmission parameter set, the at least one group of uplink information is sent to the network device, so as to be capable of determining a transmission parameter of the uplink information on each antenna panel based on a change in the transmission environment, thereby improving system performance.

Of course, the first transmission parameters used by different groups of uplink information may be the same or different, which is not specifically limited thereto in the present disclosure. Exemplarily, the at least one group of uplink information may be multiple groups of uplink information, and different groups of uplink information in the multiple groups of uplink information may be associated with different pieces of spatial information, or may be associated with the same piece of spatial information. In other words, an association relationship between the at least one group of uplink information and the at least one piece of spatial information may be a one-to-one association relationship, a one-to-many association relationship, or a many-to-one association relationship.

Exemplarily, “at least one first transmission parameter set used by the at least one group of uplink information” may be understood as: at least one first transmission parameter set that is to be used or would be used by the at least one group of uplink information.

In some embodiments, the at least one group of uplink information is associated with at least one TRP, or the at least one group of uplink information is associated with at least one antenna panel, or the at least one group of uplink information is associated with at least one uplink transmission spatial filter.

Exemplarily, different groups of uplink information in the at least one group of uplink information are associated with different TRPs (or antenna panels or uplink transmission spatial filters) in the at least one TRP, so as to realize transmission of the uplink information to multiple TRPs (or antenna panels or uplink transmission spatial filters) at the same time, or realize transmission of the uplink information through multiple antenna panels at the same time, or realize transmission of the uplink information through multiple uplink transmission spatial filters at the same time.

In some embodiments, each group of uplink information in the at least one group of uplink information includes one or more pieces of uplink information, and each group of uplink information in the at least one group of uplink information is associated with the same piece of spatial information in the at least one piece of spatial information.

Exemplarily, different pieces of uplink information in each group of uplink information in the at least one group of uplink information use the same first transmission parameter set.

In some embodiments, the same piece of spatial information includes at least one of the following information: transmission configuration indication (TCI) state information, antenna panel information, transmission reception point (TRP), control resource set (CORESET) group information, reference signal set information, beam information, or capability set information.

In some embodiments, the at least one group of uplink information is scheduled through a same DCI.

In some embodiments, each of the at least one piece of spatial information includes at least one of the following information: TCI state information, antenna panel information, TRP information, control resource set (CORESET) group information, reference signal set information, beam information, or capability set information.

It should be understood that the TCI state involved in the present disclosure may include a TCI state indicated by both uplink and downlink or TCI states indicated by both uplink and downlink respectively.

For example, in some embodiments, the spatial information may be one of antenna panel information, TRP information, CORESET group information, reference signal set information, TCI state information, beam information, and capability set information. For another example, the spatial information may include antenna panel information and TRP information, or the spatial information may include antenna panel information, TRP information and reference signal set information. The contents included in the spatial information are not listed one by one herein, and the embodiments of the present disclosure do not limit a content that may be included in the spatial information.

Optionally, the antenna panel information may include at least one of: an antenna panel ID, or an antenna panel index.

Optionally, the CORESET group information may include at least one of: a CORESET group ID, or a CORESET group index.

Optionally, the reference signal set information may include one or more reference signals. The reference signal may include a synchronization reference signal and/or a measurement reference signal. The synchronization reference signal is used to achieve uplink synchronization between a terminal device and a network device; the measurement reference signal is used to measure channel state information between the terminal device and the network device. The measurement reference signal may include at least one of: an SRS, phase-tracking reference signal (Phase-Tracking Reference Signal, PT-RS), demodulation reference signal (DeModulation Reference Signal, DMRS), phase tracking reference signal (Phase Tracking Reference Signal, PTRS), or channel state information-reference signal (Channel State Information-Reference Signal, CSI-RS). The contents of the reference signal are not limited in the embodiments of the present disclosure. The reference signal set information includes a reference signal set ID or a reference signal set index or a reference signal resource ID or a reference signal resource index.

Optionally, the TCI state information may include or indicate one or more TCI states or one or more TCI state IDs.

Optionally, the beam information may include one or more transmitting beams for transmitting uplink information and/or one or more receiving beams for receiving uplink information. In some embodiments, a transmitting beam may correspond to a spatial domain transmission filter (spatial domain transmission filter), and a receiving beam may correspond to a spatial domain receive filter (spatial domain receive filter).

Optionally, the capability set information may include one or more parameters. For example, the capability set information may be a capability set supported by a terminal device or reference signal information associated with a capability set supported by the terminal device. In some embodiments, the capability set information may include at least one of the following parameters: a number of SRS ports supported by the terminal device, a channel bandwidth supported by the terminal device, a number of transmitting antennas supported by the terminal device, a number of hybrid automatic repeat request (Hybrid Automatic Repeat Request, HARQ) processes supported by the terminal device, a maximum modulation mode for uplink data transmission, a maximum number of MIMO layers for uplink data transmission, a maximum modulation mode for downlink data transmission, PDSCH processing capability, PUSCH processing capability, power saving capability of the terminal device, coverage enhancement capability of the terminal device, data transmission rate improvement capability of the terminal device, short delay processing capability of the terminal device, small data transmission capability of the terminal device, inactive data transmission capability of the terminal device, transmission reliability capability of the terminal device, or URLLC data transmission capability of the terminal device. The parameters included in the capability set information in the embodiments of the present disclosure are not limited.

In some embodiments, each group of uplink information in the at least one group of uplink information includes at least one of: at least one physical uplink control channel (Physical Uplink Control Channel, PUCCH), at least one physical uplink shared channel (Physical Uplink Shared Channel, PUSCH), a PUCCH corresponding to at least one transmission layer, a PUSCH corresponding to at least one transmission layer, a PUSCH corresponding to at least one redundancy version (redundancy version, RV), at least one transmission block, at least one piece of uplink information transmitted in an FDM transmission mode, at least one piece of uplink information transmitted in an SDM transmission mode, a PUSCH associated with at least one antenna panel, or a PUCCH associated with at least one antenna panel.

Exemplarily, the at least one group of uplink information includes at least one of: a group of uplink information consisting of at least one PUCCH, a group of uplink information consisting of at least one PUSCH, a group of uplink information consisting of a PUCCH corresponding to at least one transmission layer, a group of uplink information consisting of a PUSCH corresponding to at least one transmission layer, a group of uplink information consisting of at least one PUSCH corresponding to a RV, a group of uplink information consisting of at least one transmission block, a group of uplink information consisting of at least one piece of uplink information transmitted in an FDM transmission mode, a group of uplink information consisting of at least one piece of uplink information transmitted in an SDM transmission mode, a group of uplink information consisting of a PUSCH associated with at least one antenna panel, or a group of uplink information consisting of a PUCCH associated with at least one antenna panel.

Exemplarily, each group of the at least one group of uplink information includes any one of the following: a group of uplink information consisting of at least one PUCCH, a group of uplink information consisting of at least one PUSCH, a group of uplink information consisting of a PUCCH corresponding to at least one transmission layer, a group of uplink information consisting of a PUSCH corresponding to at least one transmission layer, a group of uplink information consisting of at least one PUSCH corresponding to a RV, a group of uplink information consisting of at least one transmission block, a group of uplink information consisting of at least one piece of uplink information transmitted in an FDM transmission mode, a group of uplink information consisting of at least one piece of uplink information transmitted in an SDM transmission mode, a group of uplink information consisting of a PUSCH associated with at least one antenna panel, and a group of uplink information consisting of a PUCCH associated with at least one antenna panel.

Exemplarily, each group of uplink information in the at least one group of uplink information may include one piece of uplink information or multiple pieces of uplink information, and the one or more pieces of uplink information may be any one of the following: one or more PUCCHs, one or more PUSCHs, different transmission layers of PUCCHs, different transmission layers of PUSCHs, different RVs of PUSCHs, the same RV of PUSCHs, different transmission blocks, different RVs of the same transmission block, multiple pieces of uplink information transmitted in a FDM mode, multiple pieces of uplink information transmitted in a SDM mode, PUSCHs associated with one or more antenna panels, and PUCCHs associated with one or more antenna panels.

Exemplarily, when each group of uplink information in the at least one group of uplink information includes a PUCCH or a PUSCH, etc., the at least one group of uplink information may also be understood as at least one group of uplink channels carrying uplink information, where each group of uplink channels in the at least one group of uplink channels may include one or more uplink channels. For example, each group of uplink channels in the at least one group of uplink channels may include one or more PUCCHs. For another example, each group of uplink channels in the at least one group of uplink channels may include one or more PUSCHs. The embodiments of the present disclosure are not limited thereto.

Exemplarily, each group of uplink information may include one or more pieces of uplink information.

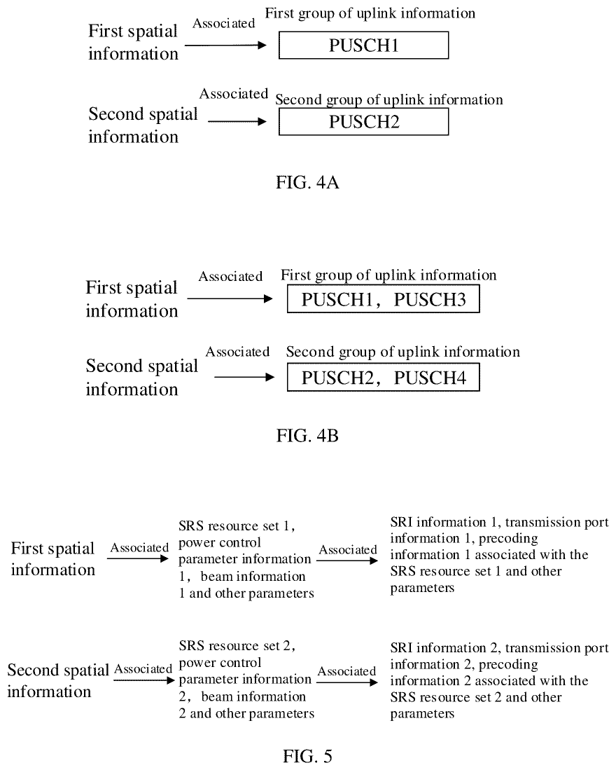

FIGS. 4A and 4B are schematic diagrams of relationships between at least one piece of spatial information and at least one group of uplink information of the embodiments of the present disclosure.

As shown in FIG. 4A, the at least one piece of spatial information may include first spatial information and second spatial information, the at least one group of uplink information may include first group of uplink information and second group of uplink information, the first spatial information is associated with the first group of uplink information, and the second spatial information is associated with the second group of uplink information. The first group of uplink information includes PUSCH 1, and the second group of uplink information includes PUSCH 2.

As shown in FIG. 4B, the at least one piece of spatial information may include first spatial information and second spatial information, the at least one group of uplink information may include first group of uplink information and second group of uplink information, the first spatial information is associated with the first group of uplink information, and the second spatial information is associated with the second group of uplink information. The first group of uplink information includes PUSCH 1 and PUSCH 3, and the second group of uplink information includes PUSCH 2 and PUSCH 4.

It should be understood that FIGS. 4A and 4B are merely examples of the present disclosure and should not be construed as a limitation to the present disclosure.

For example, in FIGS. 4A and 4B, the first group of uplink information or the second group of uplink information may include one or more PUSCHs, but in other alternative embodiments, the first group of uplink information or the second group of uplink information may include other types of information, data blocks, etc., which is not specifically limited in the present disclosure.

In some embodiments, the 210 may include:
determining, by the terminal device, at least one second transmission parameter set associated with the at least one piece of spatial information as the at least one first transmission parameter set.

In this embodiment, since the at least one group of uplink information is associated with the at least one piece of spatial information, based on this, when the at least one piece of spatial information is associated with at least one second transmission parameter set, the at least one second transmission parameter set may be directly determined as the at least one first transmission parameter set used by the at least one group of uplink information. Thus, the complexity of the terminal device in determining the at least one first transmission parameter can be reduced, which is beneficial to improving data transmission efficiency and system performance.

In some embodiments, the second transmission parameter set includes at least one of the following information: an uplink transmission spatial filter of uplink information, power control parameter information of uplink information, beam information of uplink information, precoding information of uplink information, information of a number of transmission layers of uplink information, sounding reference signal (Sounding Reference Signal, SRS) resource set information associated with uplink information, sounding reference signal resource indicator (Sounding Reference Signal Resource Indicator, SRI) information associated with uplink information, demodulation reference signal (Demodulation Reference Signal, DMRS) port information of uplink information, or transmission port information used by an SRS resource indicated by the SRI.

Exemplarily, the at least one piece of spatial information includes the first spatial information associated with the first group of uplink information in the at least one group of uplink information and the second spatial information associated with the second group of uplink information in the at least one group of uplink information, where the first spatial information is a first TCI state and the second spatial information is a second TCI state. Optionally, a TCI state ID of the first TCI state is smaller than a TCI state ID of the second TCI state. Optionally, in a case where the at least one piece of spatial information includes a plurality of TCI states, the plurality of TCI states are arranged in order of TCI state ID from small to large or from large to small. Furthermore, the at least one second transmission parameter set associated with the at least one piece of spatial information includes a second transmission parameter set associated with the first spatial information and a second transmission parameter set associated with the second spatial information, the second transmission parameter set associated with the first spatial information may include an uplink transmission spatial filter associated with the first spatial information, and the second transmission parameter set associated with the second spatial information may include an uplink transmission spatial filter associated with the second spatial information. Optionally, the uplink transmission spatial filters involved in the present disclosure are used to indicate a beam direction of uplink information.

Exemplarily, the at least one piece of spatial information includes the first spatial information associated with the first group of uplink information in the at least one group of uplink information and the second spatial information associated with the second group of uplink information in the at least one group of uplink information, where the first spatial information is a first TCI state and the second spatial information is a second TCI state. Optionally, a TCI state ID of the first TCI state is smaller than a TCI state ID of the second TCI state. Optionally, in a case where the at least one piece of spatial information includes a plurality of TCI states, the plurality of TCI states are arranged in order of TCI state ID from small to large or from large to small. Furthermore, the at least one second transmission parameter set associated with the at least one piece of spatial information includes a second transmission parameter set associated with the first spatial information and a second transmission parameter set associated with the second spatial information. The second transmission parameter set associated with the first spatial information may include one or more of power control parameter information, precoding information and information of a number of transmission layers associated with the first spatial information, and the second transmission parameter set associated with the second spatial information may include one or more of power control parameter information, precoding information and information of a number of transmission layers associated with the second spatial information.

Exemplarily, the at least one piece of spatial information includes the first spatial information associated with the first group of uplink information in the at least one group of uplink information and the second spatial information associated with the second group of uplink information in the at least one group of uplink information, where the first spatial information is a first TCI state and the second spatial information is a second TCI state. Optionally, a TCI state ID of the first TCI state is smaller than a TCI state ID of the second TCI state. Optionally, in a case where the at least one piece of spatial information includes a plurality of TCI states, the plurality of TCI states are arranged in order of TCI state ID from small to large or from large to small. Furthermore, the at least one second transmission parameter set associated with the at least one piece of spatial information includes a second transmission parameter set associated with the first spatial information and a second transmission parameter set associated with the second spatial information, the second transmission parameter set associated with the first spatial information may include SRI information associated with the first spatial information, and the second transmission parameter set associated with the second spatial information may include SRI information associated with the second spatial information.

In some embodiments, the DMRS port information of the uplink information is DMRS port information used by uplink information associated with the SRS resource set, and/or the transmission port information used by the SRS resource indicated by the SRI is transmission port information used by uplink information associated with the SRS resource set.

In some embodiments, the 210 may include:
determining, by the terminal device, at least one second transmission parameter set associated with the at least one piece of spatial information; determining, by the terminal device, at least one third transmission parameter set associated with the at least one second transmission parameter set as the at least one first transmission parameter set.

In this embodiment, by introducing at least one second transmission parameter set, and associating the at least one second transmission parameter set with the at least one piece of spatial information and the at least one third transmission parameter set, not only the at least one first transmission parameter set may be determined based on the at least one piece of spatial information, but it is also beneficial to design the at least one second transmission parameter to be consistent with other parameters used to determine a transmission parameter of the uplink information. For example, taking a parameter used to determine the transmission parameter of the uplink information as an SRS resource or an SRS resource set as an example, in a case where the at least one second transmission parameter set is designed as at least one SRS resource (or at least one SRS resource set) in the present disclosure, the terminal device, after determining the at least one SRS resource (or at least one SRS resource set) associated with the at least one piece of spatial information, may determine the at least one first transmission parameter based on the association relationship between the at least one piece of spatial information and the at least one SRS resource (or at least one SRS resource set), and the association relationship between the at least one SRS resource (or at least one SRS resource set) and the at least one third transmission parameter set. Since the SRS resource set information in the standard is associated with a transmission parameter set, when the at least one first transmission parameter is determined in this way, a magnitude of a change to the standard protocol is reduced, thereby improving system performance.

In some embodiments, the second transmission parameter set includes sounding reference signal (SRS) resource set information.

In some embodiments, the third transmission parameter set includes at least one of the following: precoding information used by uplink information, information of a number of transmission layers used by uplink information, sounding reference signal resource indicator (SRI) information associated with uplink information, demodulation reference signal (DMRS) port information used by uplink information, or transmission port information used by uplink information.

In this embodiment, after the terminal device determines at least one SRS resource set associated with the at least one piece of spatial information, the terminal device determines the at least one first transmission parameter set used by the at least one group of uplink information based on the SRS resource or the SRS resource set, and then the terminal device sends the at least one group of uplink information according to the at least one first transmission parameter set, thereby reducing a magnitude of a change to the standard protocol and, thereby, being able to improve system performance.

Exemplarily, the at least one piece of spatial information includes the first spatial information associated with the first group of uplink information in the at least one group of uplink information and the second spatial information associated with the second group of uplink information in the at least one group of uplink information, where the first spatial information is a first TCI state and the second spatial information is a second TCI state. Optionally, a TCI state ID of the first TCI state is smaller than a TCI state ID of the second TCI state. Optionally, when the at least one piece of spatial information includes the plurality of TCI states, the plurality of TCI states are arranged in order of the TCI state ID from small to large or from large to small. Furthermore, the at least one second transmission parameter set associated with the at least one piece of spatial information includes a second transmission parameter set associated with the first spatial information and a second transmission parameter set associated with the second spatial information, the second transmission parameter set associated with the first spatial information may include an SRS resource set associated with the first spatial information, and the second transmission parameter set associated with the second spatial information may include an SRS resource set associated with the second spatial information.

That is to say, the terminal device may, based on spatial information associated with each uplink information in the at least one group of uplink information, determine the SRS resource set information associated with the each group of uplink information, and further, the terminal device may determine the first transmission parameter set used by the each group of uplink information based on the SRS resource set information associated with the each group of uplink information. For example, the terminal device may directly determine the transmission parameter set associated with the SRS resource set information associated with the each group of uplink information as the first transmission parameter set used by the each group of uplink information. Exemplarily, taking the first transmission parameter set used by the each group of uplink information including precoding information and information of a number of transmission layers as an example, the terminal device may directly determine the precoding information and the information of a number of transmission layers associated with the SRS resource set information associated with the each group of uplink information as the precoding information and the information of a number of transmission layers used by the each group of uplink information.

In some embodiments, the first transmission parameter set used by the each group of uplink information in the at least one group of uplink information further includes at least one of the following items associated with the spatial information associated with the each group of uplink information: an uplink transmission spatial filter used by uplink information, power control parameter information used by uplink information, or beam information used by uplink information.

In this embodiment, after the terminal device determines the at least one SRS resource set associated with the at least one piece of spatial information, the terminal device determines a solution for the transmission parameter of the uplink information based on the SRS resource or the SRS resource set, determines a part of the transmission parameters used by the at least one group of uplink information, and determines another part of the transmission parameters used by the at least one group of uplink information through the parameters associated with the at least one piece of spatial information. As a result, the terminal device may send the at least one group of uplink information based on the part of the transmission parameters and the another part of the transmission parameters, which not only reduces a magnitude of a change to the standard protocol, but also improves the flexibility of determining a transmission parameter of uplink information, thereby improving system performance.

Exemplarily, the at least one piece of spatial information is associated with at least one second transmission parameter set, the at least one second transmission parameter set is associated with at least one third transmission parameter set, and the terminal device determines the at least one third transmission parameter set as the at least one first transmission parameter set. For example, the at least one piece of spatial information includes a first TCI state and a second TCI state, and the at least one second transmission parameter set includes a first second transmission parameter set and a second second transmission parameter set. The first TCI state and the second TCI state are associated with the first second transmission parameter set and the second second transmission parameter set, respectively. In case 1, the first information is used to indicate an association relationship between the at least one piece of spatial information and the at least one second transmission parameter set (for example, the second transmission parameter set includes an SRS resource set), and the at least one second transmission parameter set is associated with the at least one third transmission parameter set (for example, the third transmission parameter set includes precoding information, information of a number of transmission layers, and power control parameter information), and the terminal device determines the at least one third transmission parameter set as the at least one first transmission parameter set. In another case 2, the first information is used to indicate the association relationship between the at least one piece of spatial information and the at least one second transmission parameter set (for example, the second transmission parameter set includes an SRS resource set and power control parameter information), and a part (SRS resource set) of the transmission parameters in the at least one second transmission parameter set is associated with the at least one third transmission parameter set (for example, the third transmission parameter set includes precoding information and information of a number of transmission layers), and the terminal device determines another part (power control parameter information) of the transmission parameters in the at least one second transmission parameter set and the at least one third transmission parameter set as the at least one first transmission parameter set. Optionally, the network device may configure whether the transmission parameter in the second transmission parameter set belongs to the first transmission parameter set. For example, the network device configures whether the power control parameter information is associated with the spatial information (TCI state). If the power control parameter information is configured to be associated with the spatial information, the first transmission parameter set is determined according to case 2; if the power control parameter information is configured not to be associated with the spatial information, the first transmission parameter set is determined according to the case 1.

Exemplarily, the at least one piece of spatial information includes the first spatial information associated with the first group of uplink information in the at least one group of uplink information and the second spatial information associated with the second group of uplink information in the at least one group of uplink information, where the first spatial information is a first TCI state and the second spatial information is a second TCI state. Optionally, a TCI state ID of the first TCI state is smaller than a TCI state ID of the second TCI state. Optionally, when the at least one piece of spatial information includes a plurality of TCI states, the plurality of TCI states are arranged in order of the TCI state ID from small to large or from large to small. Further, the at least one second transmission parameter set associated with the at least one piece of spatial information includes a second transmission parameter set associated with the first spatial information and a second transmission parameter set associated with the second spatial information; the second transmission parameter set associated with the first spatial information may include one or more of the SRS resource set associated with the first spatial information, the uplink transmission spatial filter associated with the first spatial information, the power control parameter information associated with the first spatial information, and the beam information associated with the first spatial information; the second transmission parameter set associated with the second spatial information may include one or more of the SRS resource set associated with the second spatial information, the uplink transmission spatial filter associated with the second spatial information, the power control parameter information associated with the second spatial information, and the beam information associated with the second spatial information. That is to say, the terminal device may determine the second transmission parameter (for example, one or more of the SRS resource set information associated with the each group of uplink information in the at least one group of uplink information, the uplink transmission spatial filter associated with the each group of uplink information, the power control parameter information associated with the each group of uplink information, and the beam information associated with the each group of uplink information) associated with the each group of uplink information based on the spatial information associated with the each group of uplink information. Furthermore, the terminal device may determine the first transmission parameter set used by the each group of uplink information based on the second transmission parameter associated with the each group of uplink information (for example, one or more of the SRS resource set information associated with the each group of uplink information, the uplink transmission spatial filter associated with the each group of uplink information, the power control parameter information associated with the each group of uplink information, and the beam information associated with the each group of uplink information). Exemplarily, taking the first transmission parameter set used by the each group of uplink information including the precoding information and the information of a number of transmission layers as an example, the terminal device may directly determine the precoding information and the information of a number of transmission layers associated with the second transmission parameter associated with the each group of uplink information (for example, one or more of the SRS resource set information associated with the each group of uplink information, the uplink transmission spatial filter associated with the each group of uplink information, the power control parameter information associated with the each group of uplink information, and the beam information associated with the each group of uplink information) as the precoding information and the information of a number of transmission layers used by the each group of uplink information.

FIG. 5 is a schematic diagram of an association relationship between at least one second transmission parameter set and at least one third transmission parameter set provided in the embodiments of the present disclosure.

As shown in FIG. 5, the at least one piece of spatial information includes the first spatial information associated with the first group of uplink information in the at least one group of uplink information and the second spatial information associated with the second group of uplink information in the at least one group of uplink information, where the first spatial information is a first TCI state and the second spatial information is a second TCI state. Optionally, a TCI state ID of the first TCI state is smaller than a TCI state ID of the second TCI state. Optionally, when the at least one piece of spatial information includes a plurality of TCI states, the plurality of TCI states are arranged in order of the TCI state ID from small to large or from large to small.

Furthermore, the at least one second transmission parameter set associated with the at least one piece of spatial information includes a second transmission parameter set associated with the first spatial information and a second transmission parameter set associated with the second spatial information; where the second transmission parameter set associated with the first spatial information may include a parameter such as SRS resource set 1, power control parameter information 1 and beam information 1, and accordingly, the third transmission parameter set associated with the second transmission parameter set associated with the first spatial information may include: the following information associated with the SRS resource set 1: parameters such as precoding information 1, SRI information and transmission port information 1. In addition, the second transmission parameter set associated with the second spatial information may include parameters such as SRS resource set 2, power control parameter information 2 and beam information 2. Correspondingly, the third transmission parameter set associated with the second transmission parameter set associated with the second spatial information may include: the following information associated with the SRS resource set 2: parameters such as precoding information 2, the SRI information and transmission port information 2.

It should be understood that FIG. 5 is merely an example of the present disclosure and should not be construed as a limitation to the present disclosure.

For example, in other alternative embodiments, the third transmission parameter set associated with the second transmission parameter set associated with the first spatial information may also include DMRS port information, and the third transmission parameter set associated with the second transmission parameter set associated with the second spatial information may also include DMRS port information. Optionally, the DMRS port information associated with the second transmission parameter set associated with the first spatial information and the DMRS port information associated with the second transmission parameter set associated with the second spatial information may be different, that is, the uplink information associated with the first spatial information and the uplink information associated with the second spatial information may use different pieces of DMRS port information.

In some embodiments, the method 200 further includes:
receiving, by the terminal device, the first information sent from the network device, where the first information includes at least one of the following: an association relationship between the at least one piece of spatial information and the at least one second transmission parameter set, or an association relationship between the at least one piece of spatial information and at least one uplink resource set where the at least one group of uplink information is located.

Exemplarily, when the first information includes the association relationship between the at least one piece of spatial information and the at least one second transmission parameter set, the terminal device, after determining the at least one piece of spatial information associated with the at least one group of uplink information, may, based on the first information, determine the transmission parameter set corresponding to the each spatial information in the at least one piece of spatial information as the second transmission parameter set associated with the each spatial information.

Exemplarily, when the first information includes the association relationship between the at least one piece of spatial information and the at least one uplink resource set where the at least one group of uplink information is located, the at least one piece of spatial information may be used to indicate the at least one first transmission parameter set. In other words, the terminal device, after determining the at least one piece of spatial information associated with the at least one group of uplink information, may, based on the first information, determine at least one uplink resource set associated with the at least one piece of spatial information, and send the at least one group of uplink information to the network device on the at least one uplink resource set based on the at least one spatial transmission parameter set indicated by the at least one piece of spatial information.

In this embodiment, when the first information includes the association relationship between the at least one piece of spatial information and the at least one uplink resource set where the at least one group of uplink information is located, it is equivalent to directly associating the uplink information transmitted on the at least one uplink resource set with the at least one piece of spatial information, thereby avoiding the network device separately indicating the at least one piece of spatial information to the terminal device. Based on this, the terminal device may send the at least one group of uplink information to the network device on at least one uplink resource set based on the at least one piece of spatial information associated with the at least one uplink resource set, thereby reducing signaling overhead.

Taking the first information including the association relationship between at least oneone piece of spatial information and the at least one uplink resource set where the at least one group of uplink information is located as an example, it is assumed that the at least one piece of spatial information includes a first spatial information and a second spatial information, where the first spatial information is a first TCI state and the second spatial information is a second TCI state. Optionally, a TCI state ID of the first TCI state is smaller than a TCI state ID of the second TCI state. Optionally, when the at least one piece of spatial information includes a plurality of TCI states, the plurality of TCI states are arranged in order of the TCI state ID from small to large or from large to small. Furthermore, the at least one group of uplink information includes a first group of uplink information and a second group of uplink information, an uplink resource set where the first group of uplink information is located is a first uplink resource set, and a resource set where the second group of uplink information is located is a second uplink resource set. At this time, the first information may be used to indicate at least one of:
the first spatial information being associated with the first uplink resource set, and the second spatial information being associated with the second uplink resource set;
the second spatial information being associated with the first uplink resource set, and the first spatial information being associated with the second uplink resource set;
the first spatial information being associated with the first uplink resource set; or
the second spatial information being associated with the second uplink resource set.

It should be understood that in the present disclosure, the transmission parameter set used by the at least one group of uplink information is recorded as at least one first transmission parameter set, and the transmission parameter set associated with the at least one piece of spatial information is recorded as the at least one second transmission parameter set. As for whether to directly determine the at least one second transmission parameter set as the at least one first transmission parameter set, or to determine the at least one third transmission parameter set associated with the at least one second transmission parameter set as the at least one first transmission parameter set, the present disclosure does not make any specific limitation.

Even, for each spatial information in the at least one piece of spatial information, after the terminal device determines a part of transmission parameters in the second transmission parameter set associated with the each spatial information (e.g., an SRS resource set), the terminal device may determine a part of transmission parameters (e.g., precoding information and a number of transmission layers) in the corresponding first transmission parameter set based on the transmission parameters (e.g., precoding information and a number of transmission layers) associated with a part of transmission parameters (e.g., an SRS resource set) in the second transmission parameter set. Furthermore, the terminal device may also directly determine another part of the transmission parameters associated with the each spatial information (e.g., uplink transmission spatial filter used by uplink information, power control parameter information used by uplink information, and beam information used by uplink information) as another part of the transmission parameters (e.g., uplink transmission spatial filter used by uplink information, power control parameter information used by uplink information, and beam information used by uplink information) in the corresponding first transmission parameter set, thereby enabling the terminal device to send the at least one group of uplink information based on the first transmission parameter set used by each group of uplink information.

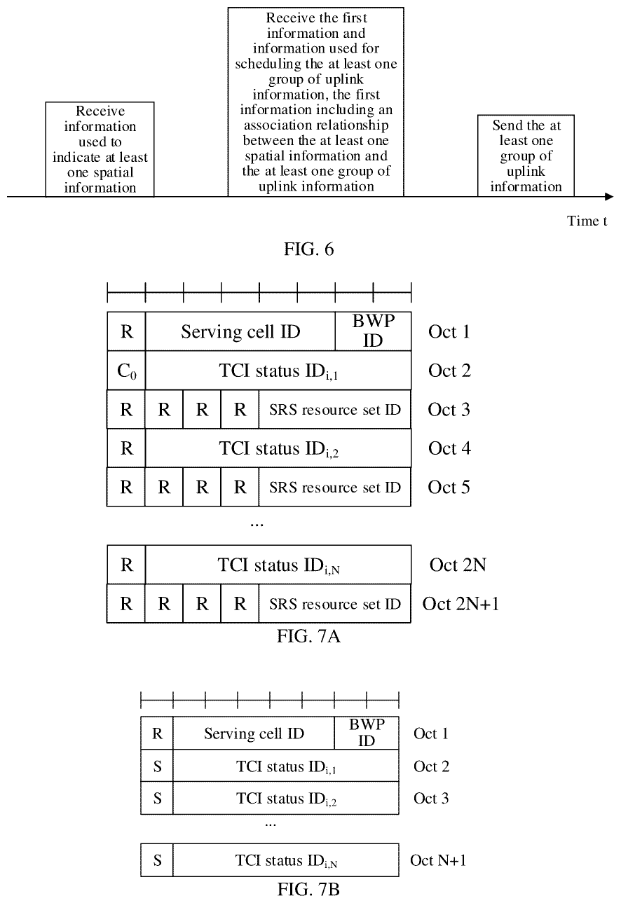

FIG. 6 is a schematic diagram of a timing relationship between first information and at least one group of uplink information provided in the embodiments of the present disclosure.

As shown in FIG. 6, the terminal device receives information for indicating at least one piece of spatial information. For example, the terminal device receives first indication information sent from a network device, and the first indication information is used to indicate the at least one piece of spatial information. Optionally, the first indication information is carried within an information field in downlink DCI format 1-1 or 1-2, or the first indication information is carried within an information field in an RRC signaling or a MAC CE. Optionally, the first indication information is also used to indicate a number of the at least one piece of spatial information. Further, the terminal device receives the first information and information used for scheduling (e.g., applicable to a scenario in which PUSCH is scheduled by DCI) or configuring (e.g., applicable to a scenario in which PUSCH is configured by RRC) the at least one group of uplink information, the first information including an association relationship between the at least one piece of spatial information and the at least one group of uplink information; for example, the terminal device receives the first information and first scheduling information, the first scheduling information being used to schedule a transmission of the at least one group of uplink information. Optionally, the first scheduling information may be carried within an information field in DCI format 0-1 or 0-2, or the first scheduling information may be carried within an information field in RRC signaling. Optionally, the first information and the first scheduling information may be carried in a same message. For example, the first information and the first scheduling information may be carried in a same DCI. Based on this, the terminal device may determine spatial information associated with the each group of uplink information in the at least one group of uplink information based on the first information, then determine the first transmission parameter set used by the each group of uplink information based on the spatial information associated with the each group of uplink information, and finally send the each group of uplink information to the network device based on the first transmission parameter set used by the each group of uplink information.

It should be noted that FIG. 6 is merely an example of the timing relationship between the first information and the at least one group of uplink information, and should not be construed as a limitation to the present disclosure. For example, in other alternative embodiments, the first information and the information used to schedule the at least one group of uplink information may have a sequential relationship. For example, the terminal device, after receiving the first information, may receive information used to schedule the at least one group of uplink information. For another example, the terminal device, before receiving the first information, may receive information used to schedule the at least one group of uplink information.

In some embodiments, the first information further includes at least one of: an association relationship between the at least one piece of spatial information and the at least one group of uplink information, or an association relationship between the at least one second transmission parameter set and the at least one first transmission parameter set.

Taking the first information including the association relationship between the at least one piece of spatial information and the at least one group of uplink information as an example, it is assumed that the at least one piece of spatial information includes first spatial information and second spatial information, where the first spatial information is a first TCI state and the second spatial information is a second TCI state. Optionally, a TCI state ID of the first TCI state is smaller than a TCI state ID of the second TCI state. Optionally, when the at least one piece of spatial information includes a plurality of TCI states, the plurality of TCI states are arranged in order of the TCI state ID from small to large or from large to small. Furthermore, the at least one group of uplink information includes a first group of uplink information and a second group of uplink information. At this time, the first information may be used to indicate at least one of:
the first spatial information being associated with the first group of uplink information, and the second spatial information being associated with the second group of uplink information;
the second spatial information being associated with the first group of uplink information, and the first spatial information being associated with the second group of uplink information;
the first spatial information being associated with the first group of uplink information; or
the second spatial information being associated with the second group of uplink information.

Of course, in other alternative embodiments, the first information may also include other information, which is not specifically limited in the present disclosure.

It should be noted that since the at least one second transmission parameter set provided in the present disclosure may be directly used as the at least one first transmission parameter set, or the at least one third transmission parameter set associated with the at least one second transmission parameter set may be taken as the at least one first transmission parameter set; therefore, the terminal device, upon detecting the first information, may only detect the association relationship between the at least one piece of spatial information and the at least one second transmission parameter set, or may detect the association relationship between the at least one second transmission parameter set and the at least one first transmission parameter set on the basis of the detection of the association relationship between the at least one piece of spatial information and the at least one second transmission parameter set. For example, when the terminal device detects the first information, for version 18 and later protocol versions, the terminal device may not detect the association relationship between the at least one second transmission parameter set and the at least one first transmission parameter set, that is, the terminal device may only detect the association relationship between the at least one piece of spatial information and the at least one second transmission parameter set. For another example, for version 18 and later protocol versions, the terminal device may detect the association relationship between the at least one second transmission parameter set and the at least one first transmission parameter set on the basis of the detection of the association relationship between the at least one piece of spatial information and the at least one second transmission parameter set. Of course, for protocol versions before version 18, the terminal device may only detect the association between the at least one piece of spatial information and the at least one second transmission parameter set, which is not specifically limited in the present disclosure.

In some embodiments, the at least one uplink resource set includes a first uplink resource set and a second uplink resource set; where an index of a resource unit in the first uplink resource set is less than an index of a resource unit in the second uplink resource set; or the index of the resource unit in the first uplink resource set is an even number and the index of the resource unit in the second uplink resource set is an odd number.

Exemplarily, the at least one group of uplink information may include a first group of uplink information and a second group of uplink information, where an uplink resource set where the first group of uplink information is located and sn uplink resource set where the second group of uplink information do not overlap.

Exemplarily, the at least one group of uplink information may include a first group of uplink information and a second group of uplink information, where an uplink resource set where the first group of uplink information is located is the first uplink resource set, and an uplink resource set where the second group of uplink information is located is the second uplink resource set.

Exemplarily, the at least one group of uplink information may include a first group of uplink information and a second group of uplink information, where an uplink resource set where the first group of uplink information is located is the second uplink resource set, and an uplink resource set where the second group of uplink information is located is the first uplink resource set.

Exemplarily, each uplink resource set in the at least one uplink resource set may include one or more uplink resource units, and the uplink resource units include but are not limited to: RB, RBG, and RE. In other words, each uplink resource set in the at least one uplink resource set may include k RBs, k RBGs or k REs, etc., where k is an integer greater than 1.

In some embodiments, the first information may include a plurality pieces of information, each piece of information of the plurality pieces of information is used to indicate one of the following: an association relationship between the at least one piece of spatial information and the at least one second transmission parameter set, an association relationship between the at least one piece of spatial information and the at least one uplink resource set where the at least one group of uplink information is located, an association relationship between the at least one piece of spatial information and the at least one group of uplink information, and an association relationship between the at least one second transmission parameter set and the at least one first transmission parameter set. For example, third information is used to indicate the association relationship between the at least one piece of spatial information and the at least one second transmission parameter set. For example, fourth information is used to indicate the association relationship between the at least one piece of spatial information and at least one uplink resource set where the at least one group of uplink information is located. For example, fifth information is used to indicate the association relationship between the at least one piece of spatial information and the at least one group of uplink information. For example, sixth information is used to indicate the association relationship between the at least one second transmission parameter set and the at least one first transmission parameter set. The plurality pieces of information included in the first information may be different fields in the first information, or may be information indicated by different control signaling.

In some embodiments, the first information is carried in downlink control information (Downlink Control Information, DCI), radio resource control (Radio Resource Control, RRC), and media access control (Media Access Control, MAC) control element (Control Element, CE).

In some embodiments, a content of the first information is determined in a predefined manner.

In some embodiments, the first information is carried within the DCI.

In this embodiment, the first information is designed to be carried in the DCI, which may increase the flexibility of the first information.

In some embodiments, the at least one piece of spatial information includes the first spatial information; where the first information is used to indicate any one of the following:
the first spatial information being associated with a first group of uplink information in the at least one group of uplink information, the first spatial information being associated with a first second transmission parameter set in the at least one second transmission parameter set, the first spatial information being associated with a second group of uplink information in the at least one group of uplink information, and the first spatial information being associated with a second second transmission parameter set in the at least one second transmission parameter set.

Optionally, the terminal device has the ability to simultaneously send at least one group of uplink information associated with at least one piece of spatial information.

Optionally, the first spatial information is used to update any one of the at least one piece of spatial information.

Exemplarily, a number of the at least one piece of spatial information is 1, and a number of the at least one group of uplink information is 2 groups.

Assume that the at least one piece of spatial information includes first spatial information, and the first spatial information is a first TCI state. Optionally, the first TCI state is indicated or configured by a network device. For example, the network device sends first indication information to a terminal device, the first indication information being used to indicate the first TCI state, and the first indication information being carried within an information field in a downlink DCI format 1-1 or 1-2, or the first indication information being carried within an information field in an RRC signaling or a MAC CE. Optionally, the first indication information is used to indicate that the number of the at least one piece of spatial information is 1. Specifically, the at least one group of uplink information is scheduled by first scheduling information, and the first scheduling information may be carried within the information field in DCI format 0-1 or 0-2, or the first scheduling information may be carried within the information field in an RRC signaling.

Based on this, in an implementation, it is assumed that the at least one group of uplink information includes a first group of uplink information and a second group of uplink information, where the first information is used to indicate that the first TCI state is associated with the first group of uplink information, or the first information is used to indicate that the first TCI state is associated with the second group of uplink information. Specifically, when the first information is used to indicate that the first TCI state is associated with the first group of uplink information, the TCI state associated with the second group of uplink information may be a default TCI state, or the same TCI state as that when uplink information was last transmitted, or a TCI state determined according to a random access process (which may also be understood as beam information of SSB or CSI-RS). When the first information is used to indicate that the first TCI state is associated with the second group of uplink information, the TCI state associated with the first group of uplink information is a default TCI state, or the same TCI state as that when uplink information was last transmitted, or a TCI state determined according to a random access process (which may also be understood as beam information of SSB or CSI-RS). That is to say, for the first group of uplink information and the second group of uplink information, only the TCI state associated with one group of uplink information is updated, and the TCI state associated with another group of uplink information continues to use a previous TCI state. In another implementation, it is assumed that the at least one group of uplink information includes a first second transmission parameter set and a second second transmission parameter set, the first information is used to indicate that the first TCI state is associated with the first second transmission parameter set, or the first information is used to indicate that the first TCI state is associated with the second second transmission parameter set. Specifically, in a case where the first information is used to indicate that the first TCI state is associated with the first second transmission parameter set, the TCI state associated with the second second transmission parameter set may be a default TCI state or the same TCI state as that when uplink information was last transmitted, or a TCI state determined according to a random access process (which may also be understood as beam information of SSB or CSI-RS). In a case where the first information is used to indicate that the first TCI state is associated with the second second transmission parameter set, the TCI state associated with the first second transmission parameter set is a default TCI state or the same TCI state as that when uplink information was last transmitted, or a TCI state determined according to a random access process (which may also be understood as beam information of SSB or CSI-RS). That is to say, for the first second transmission parameter set and the second second transmission parameter set, only one group of TCI states associated with uplink information is updated, and another group of TCI states associated with uplink information continues to use a previous TCI state.

In some embodiments, the at least one piece of spatial information includes first spatial information and second spatial information; where the first information is used to indicate:
the first spatial information being associated with a first group of uplink information in the at least one group of uplink information or a first second transmission parameter set in the at least one second transmission parameter set, and the second spatial information being associated with a second group of uplink information in the at least one group of uplink information or a second second transmission parameter set in the at least one second transmission parameter set;
the first spatial information being associated with the second group of uplink information or the second second transmission parameter set, and the second spatial information being associated with the first group of uplink information or the first second transmission parameter set.

Exemplarily, a number of the at least one piece of spatial information is 2, and a number of the at least one group of uplink information is 2 groups.

Assume that the at least one piece of spatial information includes first spatial information and second spatial information, the first spatial information is a first TCI state, and the second spatial information is a second TCI state. Optionally, the first TCI state and/or the second TCI state is indicated or configured by a network device. For example, the network device sends first indication information to a terminal device, where the first indication information is used to indicate the first TCI state and/or the second TCI state, and the first indication information is carried within an information field in a downlink DCI format 1-1 or 1-2, or the first indication information is carried within an information field in an RRC signaling or a MAC CE. Optionally, the first indication information is used to indicate that a number of the at least one piece of spatial information is 2. Specifically, the at least one group of uplink information is scheduled by first scheduling information, and the first scheduling information may be carried within the information field in a DCI format 0-1 or 0-2, or the first scheduling information may be carried within the information field in an RRC signaling. For example, both the first group of uplink information and the second group of uplink information are based on codebook or non-codebook PUSCH transmissions.

Based on this, in an implementation, it is assumed that the at least one group of uplink information includes a first group of uplink information and a second group of uplink information, and the first information is used to indicate: the first TCI state being associated with the first group of uplink information, and the second TCI state being associated with the second group of uplink information in the at least one group of uplink information; or, the first information is used to indicate: the first TCI state being associated with the second group of uplink information in the at least one group of uplink information, and the second TCI state being associated with the first group of uplink information in the at least one group of uplink information. In another implementation, it is assumed that the at least one group of uplink information includes a first group of uplink information and a second group of uplink information, and the first information is used to indicate: the first TCI state being associated with the first second transmission parameter set in the at least one second transmission parameter set, or the first TCI state being associated with the second second transmission parameter set in the at least one second transmission parameter set; or, the first information is used to indicate: the first TCI state being associated with the second second transmission parameter set in the at least one second transmission parameter set, or the first TCI state being associated with the first second transmission parameter set in the at least one second transmission parameter set.

Exemplarily, the first information is 1-bit information.

Exemplarily, it is assumed that the at least one piece of spatial information includes first spatial information and second spatial information, where the first spatial information is a first TCI state, and the second spatial information is a second TCI state. Optionally, a TCI state ID of the first TCI state is smaller than a TCI state ID of the second TCI state. Optionally, when the at least one piece of spatial information includes a plurality of TCI states, the plurality of TCI states are arranged in order of the TCI state ID from small to large or from large to small. In addition, the at least one group of uplink information includes a first group of uplink information and a second group of uplink information. In addition, the at least one second transmission parameter set associated with the at least one piece of spatial information may include a first second transmission parameter set and a second second transmission parameter set. At this time, the state value of the first information and the meaning of the first information may be as shown in the following Table 1:

TABLE 1

| The state value of the | |
|---|---|
| first information | The meaning of the first information |
| 0 | The first TCI state is associated with |
| | a first group of uplink information or a first |
| | second transmission parameter set, and the |
| | second TCI state is associated with a second |
| | group of uplink information or the second |
| | second transmission parameter set. |
| 1 | The first TCI state is associated with the |
| | second group of uplink information or the |
| | second first second transmission parameter set, |
| | and the second TCI state is associated with |
| | the first group of uplink information or |
| | the first second transmission parameter set. |

As shown in Table 1, when the state value of the first information is 0, the first information is used to indicate: the first TCI state being associated with the first group of uplink information or the first second transmission parameter set, and the second TCI state being associated with the second group of uplink information or the second second transmission parameter set. When the state value of the first information is 1, the first information is used to indicate: the first TCI state being associated with the second group of uplink information or the second second transmission parameter set, and the second TCI state being associated with the first group of uplink information or the first second transmission parameter set.

Of course, Table 1 is only an example of the present disclosure and should not be construed as a limitation to the present disclosure.

For example, in other alternative embodiments, the first information may be information with more than 1 bit.

For example, in other alternative embodiments, the state value of the first information and the meaning of the first information may adopt other corresponding ways. Exemplarily, when the state value of the first information is 1, the first information is used to indicate: the first TCI state being associated with the first group of uplink information or the first second transmission parameter set, and the second TCI state being associated with the second group of uplink information or the second second transmission parameter set. When the state value of the first information is 0, the first information is used to indicate: the first TCI state being associated with the second group of uplink information or the second second transmission parameter set, and the second TCI state being associated with the first group of uplink information or the first second transmission parameter set.

In some embodiments, the first information is carried in the DCI; the at least one piece of spatial information includes first spatial information and second spatial information; where the first information is used to indicate any one of the following;
the first spatial information being associated with a first group of uplink information in the at least one group of uplink information, or the first spatial information being associated with a first second transmission parameter set in the at least one second transmission parameter set;
the first spatial information being associated with a second group of uplink information in the at least one group of uplink information, or the first spatial information being associated with a second second transmission parameter set in the at least one second transmission parameter set;
the first spatial information being associated with the first group of uplink information or the first second transmission parameter set, and the second spatial information being associated with the second group of uplink information or the second second transmission parameter set;
the first spatial information being associated with the second group of uplink information or the second second transmission parameter set, and the second spatial information being associated with the first group of uplink information or being associated with the first second transmission parameter set.

Exemplarily, a number of the at least one piece of spatial information is 2, and a number of the at least one group of uplink information is 2 groups.

Assume that the at least one piece of spatial information includes first spatial information and second spatial information, the first spatial information is a first TCI state, and the second spatial information is a second TCI state. Optionally, the first TCI state and/or the second TCI state is indicated or configured by a network device. For example, the network device transmits first indication information to a terminal device, where the first indication information is used to indicate the first TCI state and/or the second TCI state, and the first indication information is carried within an information field in the downlink DCI format 1-1 or 1-2, or the first indication information is carried within an information field in the RRC signaling or MAC CE. Optionally, the first indication information is used to indicate that the number of the at least one piece of spatial information is 2. Specifically, the at least one group of uplink information is scheduled by first scheduling information, and the first scheduling information may be carried within the information field in the DCI format 0-1 or 0-2, or the first scheduling information may be carried within the information field in the RRC signaling. Optionally, both the first group of uplink information and the second group of uplink information are based on codebook or non-codebook PUSCH transmissions.

Based on this, in an implementation, it is assumed that the at least one group of uplink information includes a first group of uplink information and a second group of uplink information, and the first information is used to indicate any one of the following: the first TCI state being associated with the first group of uplink information in the at least one group of uplink information; the first TCI state being associated with the second group of uplink information in the at least one group of uplink information; the first TCI state being associated with the first group of uplink information in the at least one group of uplink information, and the second TCI state being associated with the second group of uplink information in the at least one group of uplink information; and the first TCI state being associated with the second group of uplink information in the at least one group of uplink information, and the second TCI state being associated with the first group of uplink information in the at least one group of uplink information. In another implementation, it is assumed that the at least one group of uplink information includes a first group of uplink information and a second group of uplink information, and the first information is used to indicate any one of the following: the first TCI state being associated with the first second transmission parameter set in the at least one second transmission parameter set; the first TCI state being associated with the second second transmission parameter set in the at least one second transmission parameter set; the first TCI state being associated with the first second transmission parameter set in the at least one second transmission parameter set, and the first TCI state being associated with the second second transmission parameter set in the at least one second transmission parameter set; the first TCI state being associated with the second second transmission parameter set in the at least one second transmission parameter set, and the first TCI state being associated with the first second transmission parameter set in the at least one second transmission parameter set.

Exemplarily, the first information is 1-bit information.

Exemplarily, it is assumed that the at least one piece of spatial information includes first spatial information and second spatial information, where the first spatial information is a first TCI state, and the second spatial information is a second TCI state. Optionally, a TCI state ID of the first TCI state is smaller than a TCI state ID of the second TCI state. Optionally, when the at least one piece of spatial information includes a plurality of TCI states, the plurality of TCI states are arranged in order of the TCI state ID from small to large or from large to small. In addition, the at least one group of uplink information includes a first group of uplink information and a second group of uplink information. In addition, the at least one second transmission parameter set associated with the at least one piece of spatial information may include a first second transmission parameter set and a second second transmission parameter set. At this time, the state value of the first information and the meaning of the first information may be as shown in Table 2 below:

TABLE 2

| The state value of the | |
|---|---|
| first information | The meaning of the first information |
| 00 | The first TCI state is associated with a |
| | first group of uplink information or a first |
| | second transmission parameter set, and |
| | the second TCI state is associated with a |
| | second group of uplink information or a |
| | second second transmission parameter set. |
| 01 | The first TCI state is associated with the |
| | second group of uplink information or the |
| | second second transmission parameter set, |
| | and the second TCI state is associated with |
| | the first group of uplink information or |
| | the first second transmission parameter set. |
| 10 | The first TCI state is associated with the |
| | first group of uplink information or the |
| | first second transmission parameter set. |
| 11 | The first TCI state is associated with the |
| | second group of uplink information or the |
| | second second transmission parameter set. |

As shown in Table 2, when the state value of the first information is 00, the first information is used to indicate that the first TCI state is associated with a first group of uplink information or a first second transmission parameter set, and the second TCI state is associated with a second group of uplink information or a second second transmission parameter set. When the state value of the first information is 01, the first information is used to indicate that the first TCI state is associated with the second group of uplink information or the second second transmission parameter set, and the second TCI state is associated with the first group of uplink information or the first second transmission parameter set. When the state value of the first information is 10, the first information is used to indicate that the first TCI state is associated with the first group of uplink information or the first second transmission parameter set. When the state value of the first information is 11, the first information is used to indicate that the first TCI state is associated with the second group of uplink information or the second second transmission parameter set.

Of course, Table 2 is only an example of the present disclosure and should not be construed as a limitation to the present disclosure.

For example, in other alternative embodiments, the first information may be information with more than 2 bits. Exemplarily, taking the first information being 3 bits as an example, when the state value of the first information is 000, the first information is used to indicate that the first TCI state is associated with the first group of uplink information or the first second transmission parameter set, and the second TCI state is associated with the second group of uplink information or the second second transmission parameter set. When the state value of the first information is 001, the first information is used to indicate that the first TCI state is associated with the second group of uplink information or the second second transmission parameter set, and the second TCI state is associated with the first group of uplink information or the first second transmission parameter set. When the state value of the first information is 010, the first information is used to indicate that the first TCI state is associated with the first group of uplink information or the first second transmission parameter set. When the state value of the first information is 011, the first information is used to indicate that the first TCI state is associated with the second group of uplink information or the second second transmission parameter set. Furthermore, when the state value of the first information is 100, 101, 110 or 111, 001, 100, 101, 110 or 111 are reserved state values.

For another example, in other alternative embodiments, the state value of the first information and the meaning of the first information may adopt other corresponding manners. Exemplarily, when the state value of the first information is 11, the first information is used to indicate that the first TCI state is associated with the first group of uplink information or the first second transmission parameter set, and the second TCI state is associated with the second group of uplink information or the second second transmission parameter set. When the state value of the first information is 10, the first information is used to indicate that the first TCI state is associated with the second group of uplink information or the second second transmission parameter set, and the second TCI state is associated with the first group of uplink information or the first second transmission parameter set. When the state value of the first information is 01, the first information is used to indicate that the first TCI state is associated with the first group of uplink information or the first second transmission parameter set. When the state value of the first information is 00, the first information is used to indicate that the first TCI state is associated with the second group of uplink information or the second second transmission parameter set.

Exemplarily, a number of the at least one piece of spatial information is 2, and a number of the at least one group of uplink information is 1 group.

Assume that the at least one piece of spatial information includes first spatial information and second spatial information, the first spatial information is a first TCI state, and the second spatial information is a second TCI state. Optionally, the first TCI state and/or the second TCI state is indicated or configured by a network device. For example, the network device sends first indication information to a terminal device, where the first indication information is used to indicate the first TCI state and/or the second TCI state, and the first indication information is carried within an information field in the downlink DCI format 1-1 or 1-2, or the first indication information is carried within an information field in the RRC signaling or MAC CE. Optionally, the first indication information is used to indicate that the number of the at least one piece of spatial information is 2. Specifically, the at least one group of uplink information is scheduled by first scheduling information, and the first scheduling information may be carried within the information field in DCI format 0-1 or 0-2, or the first scheduling information may be carried within the information field in RRC signaling. For example, both the first group of uplink information and the second group of uplink information are based on codebook or non-codebook PUSCH transmissions.

Based on this, assuming that the at least one group of uplink information includes a first group of uplink information, in a possible implementation, the first information is used to indicate that the first TCI state is associated with transmission parameter information of the first group of uplink information, and/or, the first information is used to indicate that the second TCI state is associated with transmission parameter information of the first group of uplink information.

In some embodiments, the first information is carried within the RRC signaling or the MAC CE; and each SRS resource or SRS resource set configured by the RRC signaling or the MAC CE is associated with one piece of spatial information in the at least one piece of spatial information.

In this embodiment, when the first information is designed to be carried on the MAC CE, the flexibility of the first information indication can be higher than that of the RRC signaling, and modification on physical layer protocol is relatively small, which can improve the system performance.

Exemplarily, a terminal device may be configured with at least one SRS resource set, and each SRS resource set of the at least one SRS resource set may include at least one SRS resource. The each SRS resource set or the each SRS resource of the at least one SRS resource may be associated with one or more pieces of spatial information. For example, the each SRS resource set or the each SRS resource of the at least one SRS resource may be associated with one or more TCI states of the TCI states that can be used by the terminal device.

Exemplarily, the first information includes a plurality of TCI state IDs, and each TCI state in the plurality of TCI state IDs is associated with an index of an SRS resource or an index of an SRS resource set. Each TCI state ID of the plurality of TCI state IDs is a TCI state used for uplink transmission. Optionally, every p TCI state IDs of the plurality of TCI state IDs correspond to a same DCI code point, and p is greater than or equal to 2.

Exemplarily, the first information is carried in the RRC signaling, and the RRC signaling may be implemented as the following syntax elements:
FollowUnifiedTCIstate-r18 ENUMERATED {First TCI state, Second TCI state}; or
FollowUnifiedTCIstate-r18 ENUMERATED {TCI state ID x, TCI state ID y}.

That is to say, the at least one piece of spatial information may be configured through an RRC signaling, and when at least one SRS resource set is configured for the terminal device, the each SRS resource set or each SRS resource in the at least one SRS resource may be associated with one or more pieces of spatial information. For example, the each SRS resource set or each SRS resource of the at least one SRS resource may be associated with one or more TCI states of the TCI states that can be used for the terminal device.

In some embodiments, the MAC CE includes at least one of: an identification of a serving cell, an identification of bandwidth part (BWP), an identification of the at least one piece of spatial information, an index of a sounding reference signal (SRS) resource associated with each spatial information in the at least one piece of spatial information, an index of an SRS resource set associated with the each spatial information, an identification of an uplink TCI state or a downlink TCI state, or a TCI state identification for both uplink and downlink.

In some embodiments, an index of a sounding reference signal (SRS) resource associated with the each spatial information in the at least one piece of spatial information, an index of an SRS resource set associated with the each spatial information may be the first SRS resource set, or the second SRS resource set. The first SRS resource set or the second SRS resource set is configured through RRC parameters.

FIGS. 7A and 7B are example diagrams of a MAC CE used for carrying first information provided by the embodiments of the present disclosure.

As shown in FIG. 7A, the MAC CE includes 2N+1 bytes (Oct), i.e. Oct 1 to Oct 2N+1. The Oct 1 may include a reserved bit, an identification of a serving cell, and an identification of BWP. Oct 2 may include a TCI state ID_{i,1} corresponding to a code point i, and Oct 3 may include an SRS resource set ID corresponding to the TCI state ID_{i,1}. Oct 4 may include a TCI state ID_{i,2} corresponding to the code point i, Oct 5 may include an SRS resource set ID corresponding to the TCI state ID_{i,2}, and so on. Oct 2N may include a TCI state ID_{i,N} corresponding to a code point i, and Oct 2N+1 may include an SRS resource set ID corresponding to the TCI state ID_{i,N}. In this embodiment, the first information may include an index of a sounding reference signal (SRS) resource or an index of an SRS resource set associated with each spatial information in at least one piece of spatial information. Herein, R represents a reserved bit. C₀ represents other information.

As shown in (b) of FIG. 7B, the MAC CE includes N+1 bytes (Oct), i.e. Oct 1 to Oct N+1. The Oct 1 may include a reserved bit, an identification of a serving cell, and an identification of BWP. Oct 2 may include a TCI state ID_{i,1} corresponding to a code point i, Oct 3 may include a TCI state ID_{i,2} corresponding to a code point i, and so on, Oct N+1 may include a TCI state ID_{i,N} corresponding to a code point i. In this embodiment, the first information may include that a sounding reference signal (SRS) resource or an SRS resource set associated with the each spatial information in the at least one piece of spatial information being a first SRS resource set or a second SRS resource set. Herein, S is used to indicate the first SRS resource set or the second SRS resource set.

Exemplarily, a beam direction or a spatial reception filter of a CSI-RS resource corresponding to an SRS resource set associated with a group of uplink information is the same as a beam direction or a spatial reception filter corresponding to spatial information associated with the group of uplink information. When the spatial information is a TCI state, type of QCL may be typeD. Optionally, each group of uplink information in the at least one group of uplink information is one or more PUSCHs based on non-codebook transmission.

Of course, FIGS. 7A and 7B are merely examples of the present disclosure and should not be construed as a limitation to the present disclosure.

For example, in other alternative embodiments, the MAC CE may also include other information. Alternatively, a part of the information in the MAC CE is optional information, which is not specifically limited in the present disclosure.

In some embodiments, the method 200 may further include:
determining, by the terminal device, a determining manner of the at least one first transmission parameter set;
where the determining manner of the at least one first transmission parameter includes a first determining manner and a second determining manner, the first determining manner refers to determining the at least one first transmission parameter set based on at least one second transmission parameter set associated with the at least one piece of spatial information, and the second determining manner refers to determining the at least one first transmission parameter set based on the reference signal associated with the sounding reference signal (SRS) resource or the SRS resource set associated with the at least one group of uplink information.

Exemplarily, the first determining manner may also refer to determining the at least one first transmission parameter set based on reference signal information (i.e., the at least one second transmission parameter set) associated with the at least one piece of spatial information.

In some embodiments, a terminal device determines the first determining manner or the second determining manner as the determining manner of the at least one first transmission parameter set.

In some embodiments, when a first condition is met, the terminal device determines the first determining manner as the determining manner of the at least one first transmission parameter set; or when the first condition is not met, the terminal device determines the second determining manner as the determining manner of the at least one first transmission parameter set; where the first condition refers to a first time interval being greater than or equal to a first duration; where the first time interval is an interval between a first time unit and a second time unit, the first time unit being a time unit where the ending location of an uplink control channel carrying feedback information of the at least one piece of spatial information is located, and the second time unit being a time unit where the starting location of a physical channel used to carry the at least one group of uplink information is located.

In other words, the determining manner of the at least one first transmission parameter set may be determined based on a predefined rule or the first condition.

Exemplarily, the predefined rule includes at least one of: determining the at least one first transmission parameter set based on at least one second transmission parameter set associated with the at least one piece of spatial information, determining the at least one first transmission parameter set based on the reference signal information associated with the SRS resource set or the SRS resource set associated with the at least one group of uplink information, determining the at least one first transmission parameter set based on the at least one second transmission parameter set associated with the at least one piece of spatial information when the first condition is met, or determining the at least one first transmission parameter set based on the reference signal information associated with the SRS resource set or the SRS resource set associated with the at least one group of uplink information when the first condition is not met.

Exemplarily, beam information of a group of uplink information is determined according to a predefined manner, for example, the predefined manner is determined according to reference signal information associated with spatial information associated with the group of uplink information.

Exemplarily, the first duration may be determined based on application time of the beam associated with the at least one piece of spatial information, or may be related to a capability of the terminal device. Optionally, the application time of the beam indicated by the network device needs to meet the capability of the terminal device. For example, the first duration may be application time of the beam associated with the at least one piece of spatial information.

FIG. 8 is an example diagram of a determining manner of at least one first transmission parameter set provided by the embodiments of the present disclosure.

As shown in FIG. 8, a terminal device first receives a PDCCH for indicating at least one piece of spatial information. Optionally, the PDCCH may also be used to schedule a transmission of the PDSCH. Then, the terminal device transmits a PUCCH to a network device. The PUCCH may include feedback information of the PDCCH, that is, the PUCCH may include feedback information of the at least one piece of spatial information. Of course, when the PDCCH may also be used to schedule the transmission of the PDSCH, the PUCCH may also include feedback information of the PDSCH. Finally, the terminal device determines at least one first transmission parameter set used by at least one group of uplink information according to a predefined rule, and sends the at least one group of uplink information to the network device based on the at least one first transmission parameter set.

It should be understood that FIG. 8 is merely an example of the present disclosure and should not be construed as a limitation to the present disclosure.

For example, in other alternative embodiments, PDCCH used to indicate the at least one piece of spatial information may also be used to schedule a transmission of an uplink physical channel or a transmission of other physical uplink channels, which will not be described in detail in the present disclosure.

Exemplarily, the predefined rule includes at least one of: determining according to reference signal information associated with one or more pieces of spatial information, determining according to reference signal information associated with an SRS resource set or the SRS resource set associated with a group of uplink information, determining according to reference signal information associated with one or more pieces of spatial information when the first condition is met, or determining according to an SRS resource set or reference signal information associated with an SRS resource set when the first condition is not met. Specifically, the first condition may be that the first time interval is greater than or equal to beam application time associated with one or more pieces of spatial information, the first time interval is an interval from the last symbol at the end of the feedback PUCCH of the spatial information to the first symbol of the PUSCH carrying the uplink information, and the beam application time is indicated by the network device.

In some embodiments, the terminal device receives second information sent from the network device, where the second information is used to indicate a determining manner of the at least one first transmission parameter set.

Exemplarily, the second information is used to indicate at least one of: determining beam information according to a TCI state, determining beam information according to an associated SRS resource set, or both TCI state and SRS resource set being capable of using to determine beam information.

Exemplarily, the second information may be carried in downlink control information (DCI), an RRC signaling or a MAC signaling.

Exemplarily, the second information is carried in DCI, and a relationship between the state value of the second information and the meaning of the second information may be shown in the following Table 3:

TABLE 3

| The state value of the | |
|---|---|
| second information | The meaning of the second information |
| 00 | Reserved (Reserved) |
| 01 | Determine beam information |
| | according to a TCI state |
| 10 | Determine beam information according |
| | to an associated SRS resource set |
| 11 | Both TCI state and SRS resource |
| | set being capable of using to |
| | determine beam information |

As shown in Table 3, when the state value of the second information is 00, the second information may also be used for other applications. When the state value of the second information is 01, the second information is used to indicate that the beam information is determined according to the TCI state. When the state value of the second information is 10, the second information is used to indicate that beam information is determined according to an associated SRS resource set. When the state value of the second information is 11, the second information is used to indicate that both TCI state and SRS resource set may be used to determine the beam information.

Of course, Table 3 is only an example of the present disclosure and should not be construed as a limitation to the present disclosure.

For example, in other alternative embodiments, the second information may be information of more than 2 bits. Exemplarily, taking the first information being 3 bits as an example, when the state value of the second information is 000, the second information is used to indicate that the beam information is determined according to the TCI state. When the state value of the second information is 001, the second information is used to indicate that beam information is determined according to an associated SRS resource set. When the state value of the second information is 010, the second information is used to indicate that both the TCI state and the SRS resource set may be used to determine the beam information. Furthermore, when the state value of the first information is 011, 100, 101, 110 or 111, 001, 011, 100, 101, 110 or 111 are reserved state values.

For another example, in other alternative embodiments, the state value of the second information and the meaning of the second information may adopt other corresponding manners. Exemplarily, when the state value of the second information is 11, the second information may also be used for other applications. When the state value of the second information is 10, the second information is used to indicate that the beam information is determined according to the TCI state. When the state value of the second information is 01, the second information is used to indicate that beam information is determined according to an associated SRS resource set. When the state value of the second information is 00, the second information is used to indicate that both the TCI state and the SRS resource set may be used to determine the beam information.

Exemplarily, the second information is carried in an RRC signaling, and the second information is included in PUSCH-config or a configuration of an SRS resource set.

Exemplarily, the second information is carried in a MAC signaling, such as MAC CE. The second information is used to update a determining manner of beam information of a group of uplink information.

In this embodiment, the problem of the uplink information transmitting beam ambiguity when the beam information associated with the spatial information is different from the beam information associated with the SRS resource is avoided, and thus, a determining manner of the beam information of the uplink information is provided.

The preferred implementations of the present disclosure are described in detail above in conjunction with the accompanying drawings; however, the present disclosure is not limited to the specific details in the above implementations. Within the technical concept of the present disclosure, a variety of simple modifications may be made to the technical solutions of the present disclosure, and these simple modifications all fall within the protection scope of the present disclosure. For example, the various specific technical features described in the above specific implementations may be combined in any suitable manner without contradictions. In order to avoid unnecessary repetition, the application will not further explain various possible combinations. For another example, the various implementations of the present disclosure may be arbitrarily combined, and as long as they do not violate the concept of the present disclosure, they should also be regarded as the contents disclosed in the present disclosure.

It should also be understood that in the various method embodiments of the present disclosure, values of the serial numbers of the mentioned processes do not mean the order of execution. The execution order of each process should be determined by its function and internal logic, and should not constitute any limitation on the implementation process of the embodiments of the present disclosure. In addition, in the embodiments of the present disclosure, the terms “downlink” and “uplink” are used to represent the transmission direction of a signal or data, where “downlink” is used to indicate that the transmission direction of the signal or data is a first direction from a site to a user equipment of a cell, and “uplink” is used to represent that the transmission direction of the signal or data is a second direction from a user equipment of a cell to a site, for example, a “downlink signal” represents that the transmission direction of the signal is the first direction. In addition, in the embodiments of the present disclosure, the term “and/or” is merely a term used to describe the association relationship between associated objects, indicating that three types of relationships may exist. Specifically, “A and/or B” represents three situations: A exists alone, A and B both exist, or B exists alone. Herein, the symbol “/” is used to represent that the relationship between the related objects before and after is “or”.

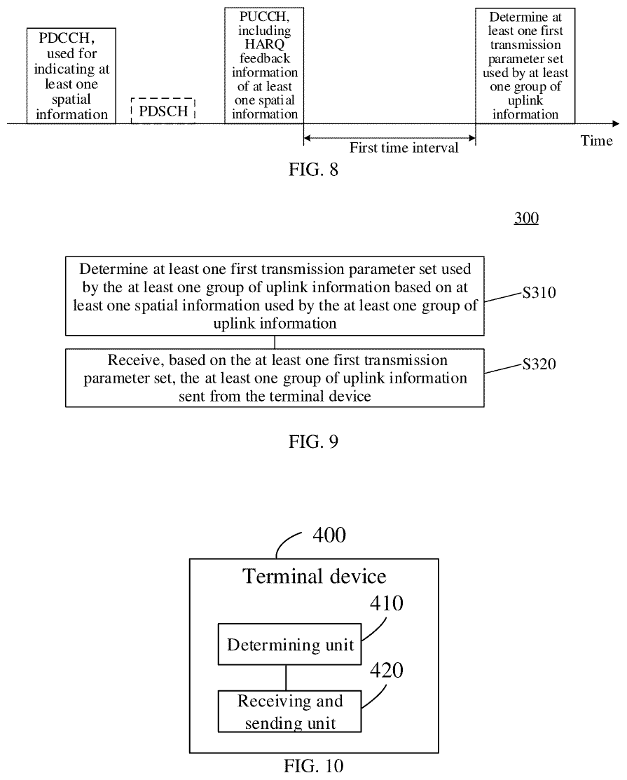

In the above, in combination with FIGS. 3 to 8, the information transmission method provided according to the embodiments of the present disclosure is described in detail from the perspective of the terminal device. The following will describe the information transmission method provided according to the embodiments of the present disclosure from the perspective of the network device in combination with FIG. 9.

FIG. 9 is a schematic flowchart of an information transmission method 300 provided in the embodiments of the present disclosure. The method 300 may be executed by the network device as shown in FIG. 1 or FIG. 2.

As shown in FIG. 9, the method 300 may include:
S310, determining at least one first transmission parameter set used by the at least one group of uplink information based on at least one piece of spatial information used by the at least one group of uplink information;
S320: receiving, based on the at least one first transmission parameter set, the at least one group of uplink information sent from the terminal device.

In some embodiments, the at least one group of uplink information is associated with at least one transmission reception point (TRP), or the at least one group of uplink information is associated with at least one antenna panel, or the at least one group of uplink information is associated with at least one uplink transmission spatial filter.

In some embodiments, the method 300 may include:
determining at least one second transmission parameter set associated with the at least one piece of spatial information as the at least one first transmission parameter set.

In some embodiments, the second transmission parameter set includes at least one of the following information: an uplink transmission spatial filter of uplink information, power control parameter information of uplink information, beam information of uplink information, precoding information of uplink information, information of a number of transmission layers of uplink information, sounding reference signal (SRS) resource set information associated with uplink information, sounding reference signal resource indicator (SRI) information associated with uplink information, demodulation reference signal (DMRS) port information of uplink information, or transmission port information used by an SRS resource indicated by the SRI.

In some embodiments, the DMRS port information of the uplink information is DMRS port information used by the uplink information associated with the SRS resource set, and/or the transmission port information used by the SRS resources indicated by the SRI is transmission port information used by the uplink information associated with the SRS resource set.

In some embodiments, the S310 may include:
determining at least one second transmission parameter set associated with the at least one piece of spatial information; and
determining at least one third transmission parameter set associated with the at least one second transmission parameter set as the at least one first transmission parameter set.

In some embodiments, the second transmission parameter set includes sounding reference signal (SRS) resource set information.

In some embodiments, the third transmission parameter set includes at least one of the following: precoding information used by uplink information, information of a number of transmission layers used by uplink information, sounding reference signal resource indicator (SRI) information associated with uplink information, demodulation reference signal (DMRS) port information used by uplink information, or transmission port information used by uplink information.

In some embodiments, the first transmission parameter set used by each group of uplink information in the at least one group of uplink information also includes at least one of the following items associated with the spatial information associated with each group of uplink information: an uplink transmission spatial filter used by uplink information, power control parameter information used by uplink information, or beam information used by uplink information.

In some embodiments, the method 300 may further include:
sending first information to the terminal device, where the first information includes at least one of: an association relationship between the at least one piece of spatial information and the at least one second transmission parameter set, or an association relationship between the at least one piece of spatial information and at least one uplink resource set where the at least one group of uplink information is located.

In some embodiments, the first information further includes at least one of: an association relationship between the at least one piece of spatial information and the at least one group of uplink information, or an association relationship between the at least one second transmission parameter set and the at least one first transmission parameter set.

In some embodiments, the at least one uplink resource set includes a first uplink resource set and a second uplink resource set; where an index of a resource unit in the first uplink resource set is less than an index of a resource unit in the second uplink resource set; or an index of a resource unit in the first uplink resource set is an even number and an index of a resource unit in the second uplink resource set is an odd number.

In some embodiments, the first information is carried in downlink control information (DCI), a radio resource control (RRC) signaling or a media access control (MAC) control element (CE).

In some embodiments, the first information is carried in the DCI; and the at least one piece of spatial information includes first spatial information; where the first information is used to indicate any one of the following;
the first spatial information being associated with a first group of uplink information in the at least one group of uplink information, the first spatial information being associated with a first second transmission parameter set in the at least one second transmission parameter set, the first spatial information being associated with a second group of uplink information in the at least one group of uplink information, and the first spatial information being associated with a second second transmission parameter set in the at least one second transmission parameter set.

In some embodiments, the first information is carried in the DCI; and the at least one piece of spatial information includes first spatial information and second spatial information; where the first information is used to indicate:
the first spatial information being associated with a first group of uplink information in the at least one group of uplink information or a first second transmission parameter set in the at least one second transmission parameter set, and the second spatial information being associated with a second group of uplink information in the at least one group of uplink information or a second second transmission parameter set in the at least one second transmission parameter set; and
the first spatial information being associated with the second group of uplink information or the second second transmission parameter set, and the second spatial information being associated with the first group of uplink information or associated with the first second transmission parameter set.

In some embodiments, the first information is carried in the DCI; and the at least one piece of spatial information includes first spatial information and second spatial information; where the first information is used to indicate any one of the following;
the first spatial information being associated with a first group of uplink information in the at least one group of uplink information, or the first spatial information being associated with a first second transmission parameter set in the at least one second transmission parameter set;
the first spatial information being associated with a second group of uplink information in the at least one group of uplink information, or the first spatial information being associated with a second second transmission parameter set in the at least one second transmission parameter set;
the first spatial information being associated with the first group of uplink information or the first second transmission parameter set, and the second spatial information being associated with the second group of uplink information or the second second transmission parameter set; and
the first spatial information being associated with the second group of uplink information or the second second transmission parameter set, and the second spatial information being associated with the first group of uplink information or the first second transmission parameter set.

In some embodiments, the first information is carried in the RRC signaling or the MAC CE; and each sounding reference signal (SRS) resource or SRS resource set configured by the RRC signaling or the MAC CE is associated with a piece of spatial information in the at least one piece of spatial information.

In some embodiments, the MAC CE includes at least one of: an identification of a serving cell, an identification of band width part (BWP), an identification of at least one piece of spatial information, an index of a sounding reference signal (SRS) resource associated with each spatial information in the at least one piece of spatial information, or an index of an SRS resource set associated with the each spatial information.

In some embodiments, the method 300 may further include:
determining a determining manner of the at least one first transmission parameter set;
where the determining manner of the at least one first transmission parameter includes a first determining manner and a second determining manner, the first determining manner refers to determining the at least one first transmission parameter set based on at least one second transmission parameter set associated with the at least one piece of spatial information, and the second determining manner refers to determining the at least one first transmission parameter set based on the reference signal associated with the SRS resource set or the SRS resource associated with the at least one group of uplink information.

In some embodiments, the first determining manner or the second determining manner is determined as the determining manner of the at least one first transmission parameter set.

In some embodiments, when the first condition is met, the first determining manner is determined as the determining manner of the at least one first transmission parameter set; or when the first condition is not met, the second determining manner is determined as the determining manner of the at least one first transmission parameter set; where the first condition refers to a first time interval being greater than or equal to a first duration; where the first time interval is an interval between a first time unit and a second time unit, the first time unit being a time unit where the ending location of an uplink control channel carrying feedback information of the at least one piece of spatial information is located, and the second time unit being a time unit where the starting location of a physical channel used to carry the at least one group of uplink information is located.

In some embodiments, second information is sent to the terminal device, where the second information is used to indicate the determining manner of the at least one first transmission parameter set.

In some embodiments, the at least one group of uplink information is scheduled by a same piece of downlink control information (DCI).

In some embodiments, each spatial information of the at least one piece of spatial information includes at least one of the following information: transmission configuration indication (TCI) state information, antenna panel information, transmission reception point (TRP) information, control resource set (CORESET) group information, reference signal set information, beam information, or capability set information.

In some embodiments, each group of uplink information in the at least one group of uplink information includes at least one of: at least one physical uplink control channel (PUCCH), at least one physical uplink shared channel (PUSCH), a PUCCH corresponding to at least one transmission layer, a PUSCH corresponding to at least one transmission layer, a PUSCH corresponding to at least one redundancy version (RV), at least one transmission block, at least one piece of uplink information transmitted in a frequency division multiplexing (FDM) transmission mode, at least one piece of uplink information transmitted in a spatial division multiplexing (SDM) transmission mode, a PUSCH associated with at least one antenna panel, or a PUCCH associated with at least one antenna panel.

It should be understood that the steps in the information transmission method 300 may refer to the corresponding steps in the information transmission method 200, which will not be repeated herein for the sake of brevity.

The method embodiments of the present disclosure are described in detail above in conjunction with FIGS. 1 to 9, and the apparatus embodiments of the present disclosure are described in detail below in conjunction with FIGS. 10 to 12.

FIG. 10 is a schematic block diagram of a terminal device of the embodiments of the present disclosure.

As shown in FIG. 10, the terminal device may include:
a determining unit 410, configured to determine, based on at least one piece of spatial information associated with at least one group of uplink information, at least one first transmission parameter set used by the at least one group of uplink information;
a receiving and sending unit 420, configured to send, based on the at least one first transmission parameter set, the at least one group of uplink information to a network device.

In some embodiments, the at least one group of uplink information is associated with at least one transmission reception point (TRP), or the at least one group of uplink information is associated with at least one antenna panel, or the at least one group of uplink information is associated with at least one uplink transmission spatial filter.

In some embodiments, the determining module 410 is specifically configured to:
determine at least one second transmission parameter set associated with the at least one piece of spatial information as the at least one first transmission parameter set.

In some embodiments, the second transmission parameter set includes at least one of the following information: an uplink transmission spatial filter of uplink information, power control parameter information of uplink information, beam information of uplink information, precoding information of uplink information, information of a number of transmission layers of uplink information, sounding reference signal (SRS) resource set information associated with uplink information, sounding reference signal resource indicator (SRI) information associated with uplink information, demodulation reference signal (DMRS) port information of uplink information, or transmission port information used by an SRS resource indicated by the SRI.

In some embodiments, the DMRS port information of the uplink information is the DMRS port information used by the uplink information associated with the SRS resource set, and/or the transmission port information used by the SRS resource indicated by the SRI is the transmission port information used by the uplink information associated with the SRS resource set.

In some embodiments, the determining module 410 is specifically configured to:
determine at least one second transmission parameter set associated with the at least one piece of spatial information;
determine at least one third transmission parameter set associated with the at least one second transmission parameter set as the at least one first transmission parameter set.

In some embodiments, the second transmission parameter set includes sounding reference signal (SRS) resource set information.

In some embodiments, the third transmission parameter set includes at least one of the following: precoding information used by uplink information, information of a number of transmission layers used by uplink information, sounding reference signal resource indicator (SRI) information associated with uplink information, demodulation reference signal (DMRS) port information used by uplink information, or transmission port information used for uplink information.

In some embodiments, the first transmission parameter set used by each group of uplink information in the at least one group of uplink information further includes at least one of the following items associated with the spatial information associated with each group of uplink information: an uplink transmission spatial filter used by uplink information, power control parameter information used by uplink information, or beam information used by uplink information.

In some embodiments, the receiving and sending unit 420 is further configured to:
receive first information sent from the network device, where the first information includes at least one of: an association relationship between the at least one piece of spatial information and the at least one second transmission parameter set, or an association relationship between the at least one piece of spatial information and at least one uplink resource set where the at least one group of uplink information is located.

In some embodiments, the first information further includes at least one of: an association relationship between the at least one piece of spatial information and the at least one group of uplink information, or an association relationship between the at least one second transmission parameter set and the at least one first transmission parameter set.

In some embodiments, the at least one uplink resource set includes a first uplink resource set and a second uplink resource set; where an index of a resource unit in the first uplink resource set is less than an index of a resource unit in the second uplink resource set; or the index of the resource unit in the first uplink resource set is an even number and the index of the resource unit in the second uplink resource set is an odd number.

In some embodiments, the first information is carried in downlink control information (DCI), radio resource control (RRC) signaling or media access control (MAC) control element (CE).

In some embodiments, the first information is carried in the DCI; the at least one piece of spatial information includes first spatial information; where the first information is used to indicate any one of the following:

the first spatial information being associated with a first group of uplink information in the at least one group of uplink information, the first spatial information being associated with a first second transmission parameter set in the at least one second transmission parameter set, the first spatial information being associated with a second group of uplink information in the at least one group of uplink information, and the first spatial information being associated with a second second transmission parameter set in the at least one second transmission parameter set.

In some embodiments, the first information is carried in the DCI; and the at least one piece of spatial information includes first spatial information and second spatial information; where the first information is used to indicate:
the first spatial information being associated with a first group of uplink information in the at least one group of uplink information or a first second transmission parameter set in the at least one second transmission parameter set, and the second spatial information being associated with a second group of uplink information in the at least one group of uplink information or a second second transmission parameter set in the at least one second transmission parameter set; and
the first spatial information being associated with the second group of uplink information or the second second transmission parameter set, and the second spatial information being associated with the first group of uplink information or the first second transmission parameter set.

In some embodiments, the first information is carried in the DCI; and the at least one piece of spatial information includes first spatial information and second spatial information; where the first information is used to indicate any one of the following:
the first spatial information being associated with a first group of uplink information in the at least one group of uplink information, or the first spatial information being associated with a first second transmission parameter set in the at least one second transmission parameter set;
the first spatial information being associated with a second group of uplink information in the at least one group of uplink information, or the first spatial information being associated with a second second transmission parameter set in the at least one second transmission parameter set;
the first spatial information being associated with the first group of uplink information or the first second transmission parameter set, and the second spatial information being associated with the second group of uplink information or the second second transmission parameter set; and
the first spatial information being associated with the second group of uplink information or the second second transmission parameter set, and the second spatial information being associated with the first group of uplink information or the first second transmission parameter set.

In some embodiments, the first information is carried in the RRC signaling or the MAC CE; and each sounding reference signal (SRS) resource or SRS resource set configured by the RRC signaling or the MAC CE is associated with one piece of spatial information in the at least one piece of spatial information.

In some embodiments, the MAC CE includes at least one of: an identification of a serving cell, an identification of band width part (BWP), an identification of at least one piece of spatial information, an index of a sounding reference signal (SRS) resource associated with each spatial information in the at least one piece of spatial information, or an index of an SRS resource set associated with each spatial information.

In some embodiments, the determining module 410 is further configured to:
determine a determining manner of the at least one first transmission parameter set;
where the determining manner of the at least one first transmission parameter includes a first determining manner and a second determining manner, the first determining manner refers to determining the at least one first transmission parameter set based on at least one second transmission parameter set associated with the at least one piece of spatial information, and the second determining manner refers to determining the at least one first transmission parameter set based on a reference signal associated with a sounding reference signal (SRS) resource or an SRS resource set associated with the at least one group of uplink information.

In some embodiments, the determining module 410 is specifically configured to:
determine the first determining manner or the second determining manner as the determining manner for the at least one first transmission parameter set.

In some embodiments, the determining module 410 is specifically configured to:
in a case where the first condition is met, determine the first determining manner as the determining manner of the at least one first transmission parameter set; or
in a case where the first condition is not met, determine the second determining manner as the determining manner of the at least one first transmission parameter set;
where the first condition refers to a first time interval being greater than or equal to a first duration; where the first time interval is an interval between a first time unit and a second time unit, the first time unit being a time unit where the ending location of an uplink control channel carrying feedback information of the at least one piece of spatial information is located, and the second time unit being a time unit where the starting location of a physical channel used to carry the at least one group of uplink information is located.

In some embodiments, the receiving and sending unit 420 is further configured to:
receive second information sent from the network device, where the second information is used to indicate a determining manner of the at least one first transmission parameter set.

In some embodiments, the at least one group of uplink information is scheduled by a same piece of downlink control information (DCI).

In some embodiments, each spatial information of the at least one piece of spatial information includes at least one of the following information: transmission configuration indication (TCI) state information, antenna panel information, transmission reception point (TRP) information, control resource set (CORESET) group information, reference signal set information, beam information, or capability set information.

In some embodiments, each group of uplink information in the at least one group of uplink information includes at least one of the following: at least one physical uplink control channel (PUCCH), at least one physical uplink shared channel (PUSCH), a PUCCH corresponding to at least one transmission layer, a PUSCH corresponding to at least one transmission layer, at least one PUSCH corresponding to a redundancy version (RV), at least one transmission block, at least one piece of uplink information transmitted in a frequency division multiplexing (FDM) transmission mode, at least one piece of uplink information transmitted in a spatial division multiplexing (SDM) transmission mode, a PUSCH associated with at least one antenna panel, or a PUCCH associated with at least one antenna panel.

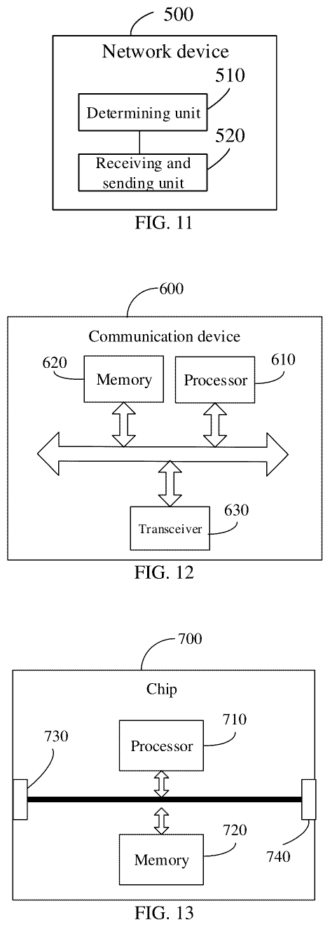

It should be understood that the apparatus embodiments and the method embodiments may correspond to each other, and similar descriptions may refer to the method embodiments. Specifically, the terminal device 400 shown in FIG. 10 may correspond to the corresponding subject in the method 200 for executing the embodiments of the present disclosure, and the aforementioned and other operations and/or functions of each unit in the terminal device 400 are respectively for implementing the corresponding processes in each method provided in the embodiments of the present disclosure, which will not be repeated herein for the sake of brevity. FIG. 11 is a schematic block diagram of a network device of the embodiments of the present disclosure.

As shown in FIG. 11, the network device may include:
a determining unit 510, configured to determine, based on at least one piece of spatial information used by at least one group of uplink information, at least one first transmission parameter set used by at least one group of uplink information;
a receiving and sending unit 520, configured to receive the at least one group of uplink information sent from the terminal device based on the at least one first transmission parameter set.

In some embodiments, the at least one group of uplink information is associated with at least one transmission reception point (TRP), or the at least one group of uplink information is associated with at least one antenna panel, or the at least one group of uplink information is associated with at least one uplink transmission spatial filter.

In some embodiments, the determining module 510 is specifically configured to:
determine at least one second transmission parameter set associated with the at least one piece of spatial information as the at least one first transmission parameter set.

In some embodiments, the second transmission parameter set includes at least one of the following information: an uplink transmission spatial filter of uplink information, power control parameter information of uplink information, beam information of uplink information, precoding information of uplink information, number of transmission layers of uplink information, sounding reference signal (SRS) resource set information associated with uplink information, sounding reference signal resource indicator (SRI) information associated with uplink information, demodulation reference signal (DMRS) port information of uplink information, or transmission port information used by an SRS resource indicated by the SRI.

In some embodiments, the DMRS port information of the uplink information is DMRS port information used by uplink information associated with the SRS resource set, and/or the transmission port information used by the SRS resources indicated by the SRI is transmission port information used by the uplink information associated with the SRS resource set.

In some embodiments, the determining module 510 is specifically configured to:
determine at least one second transmission parameter set associated with the at least one piece of spatial information; and
determine at least one third transmission parameter set associated with the at least one second transmission parameter set as the at least one first transmission parameter set.

In some embodiments, the second transmission parameter set includes sounding reference signal (SRS) resource set information.

In some embodiments, the third transmission parameter set includes at least one of: precoding information used by uplink information, information of a number of transmission layers used by uplink information, sounding reference signal resource indicator (SRI) information associated with the uplink information, demodulation reference signal (DMRS) port information used by uplink information, or transmission port information used by uplink information.

In some embodiments, the first transmission parameter set used by each group of uplink information in the at least one group of uplink information further includes at least one of the following items associated with the spatial information associated with each group of uplink information: an uplink transmission spatial filter used by the uplink information, power control parameter information used by uplink information, or beam information used by uplink information.

In some embodiments, the receiving and sending unit 520 further configured to:
send first information to the terminal device, where the first information comprising at least one of: an association relationship between the at least one piece of spatial information and the at least one second transmission parameter set, or an association relationship between the at least one piece of spatial information and at least one uplink resource set where the at least one group of uplink information is located.

In some embodiments, the first information further includes at least one of: an association relationship between the at least one piece of spatial information and the at least one group of uplink information, or an association relationship between the at least one second transmission parameter set and the at least one first transmission parameter set.

In some embodiments, the at least one uplink resource set includes a first uplink resource set and a second uplink resource set; where an index of a resource unit in the first uplink resource set is less than an index of a resource unit in the second uplink resource set; or an index of a resource unit in the first uplink resource set is an even number and an index of a resource unit in the second uplink resource set is an odd number.

In some embodiments, the first information is carried in downlink control information (DCI), radio resource control (RRC) signaling or a media access control (MAC) control element (CE).

In some embodiments, the first information is carried in the DCI; and the at least one piece of spatial information includes first spatial information; where the first information is used to indicate any one of the following:
the first spatial information being associated with a first group of uplink information in the at least one group of uplink information, the first spatial information being associated with a first second transmission parameter set in the at least one second transmission parameter set, the first spatial information being associated with a second group of uplink information in the at least one group of uplink information, and the first spatial information being associated with a second second transmission parameter set in the at least one second transmission parameter set.

In some embodiments, the first information is carried in the DCI; and the at least one piece of spatial information includes first spatial information and second spatial information; where the first information is used to indicate:
the first spatial information being associated with a first group of uplink information in the at least one group of uplink information or a first second transmission parameter set in the at least one second transmission parameter set, and the second spatial information being associated with a second group of uplink information in the at least one group of uplink information or a second second transmission parameter set in the at least one second transmission parameter set; and
the first spatial information being associated with the second group of uplink information or the second second transmission parameter set, and the second spatial information being associated with the first group of uplink information or the first second transmission parameter set.

In some embodiments, the first information is carried in the DCI; and the at least one piece of spatial information includes first spatial information and second spatial information; where the first information is used to indicate any one of the following;
the first spatial information being associated with a first group of uplink information in the at least one group of uplink information, or the first spatial information being associated with a first second transmission parameter set in the at least one second transmission parameter set;
the first spatial information being associated with a second group of uplink information in the at least one group of uplink information, or the first spatial information being associated with a second second transmission parameter set in the at least one second transmission parameter set;
the first spatial information being associated with the first group of uplink information or the first second transmission parameter set, and the second spatial information being associated with the second group of uplink information or the second second transmission parameter set; and
the first spatial information being associated with the second group of uplink information or the second second transmission parameter set, and the second spatial information being associated with the first group of uplink information or the first second transmission parameter set.

In some embodiments, the first information is carried in the RRC signaling or the MAC CE; and each sounding reference signal (SRS) resource or SRS resource set configured by the RRC signaling or the MAC CE is associated with one piece of spatial information in the at least one piece of spatial information.

In some embodiments, the MAC CE includes at least one of: a serving cell ID, a BWP ID, an identification of at least one piece of spatial information, an index of an SRS resource associated with each spatial information in the at least one piece of spatial information, or an index of an SRS resource set associated with each spatial information.

In some embodiments, the determining unit 510 is further configured to:
determine a determining manner of the at least one first transmission parameter set;
where the determining manner of the at least one first transmission parameter includes a first determining manner and a second determining manner, the first determining manner refers to determining the at least one first transmission parameter set based on at least one second transmission parameter set associated with the at least one piece of spatial information, and the second determining manner refers to determining the at least one first transmission parameter set based on a reference signal associated with the SRS resource or an SRS resource set associated with the at least one group of uplink information.

In some embodiments, the determining unit 510 is specifically configured to:
determine the first determining manner or the second determining manner as the determining manner for the at least one first transmission parameter set.

In some embodiments, the determining unit 510 is specifically configured to:
in a case where the first condition is met, determine the first determining manner as the determining manner of the at least one first transmission parameter set; or in a case where the first condition is not met, determine the second determining manner as the determining manner of the at least one first transmission parameter set;
where the first condition refers to a first time interval being greater than or equal to a first duration; where the first time interval is an interval between a first time unit and a second time unit, the first time unit being a time unit where the ending location of an uplink control channel carrying feedback information of the at least one piece of spatial information is located, and the second time unit being a time unit where the starting location of a physical channel used to carry the at least one group of uplink information is located.

In some embodiments, the receiving and sending unit 520 is specifically configured to:
send second information to the terminal device, where the second information is used to indicate the determining manner of the at least one first transmission parameter set.

In some embodiments, the at least one group of uplink information is scheduled by a same piece of downlink control information (DCI).

In some embodiments, each spatial information of the at least one piece of spatial information includes at least one of the following information: transmission configuration indication (TCI) state information, antenna panel information, transmission reception point (TRP) information, control resource set (CORESET) group information, reference signal set information, beam information, or capability set information.

In some embodiments, each group of uplink information in the at least one group of uplink information includes at least one of: at least one physical uplink control channel (PUCCH), at least one physical uplink shared channel (PUSCH), a PUCCH corresponding to at least one transmission layer, a PUSCH corresponding to at least one transmission layer, at least one PUSCH corresponding to an redundancy version (RV), at least one transmission block, at least one piece of uplink information transmitted in a frequency division multiplexing (FDM) transmission mode, at least one piece of uplink information transmitted in a spatial division multiplexing (SDM) transmission mode, a PUSCH associated with at least one antenna panel, or a PUCCH associated with at least one antenna panel.

It should be understood that the device embodiments and the method embodiments may correspond to each other, and similar descriptions may refer to the method embodiments. Specifically, the network device 500 shown in FIG. 11 may correspond to the corresponding subject in the method 300 for executing the embodiments of the present disclosure, and the aforementioned and other operations and/or functions of each unit in the network device 500 are respectively for implementing the corresponding processes in each method provided in the embodiments of the present disclosure, which will not be repeated herein for the sake of brevity.

The communication device of the embodiments of the present disclosure is described above from the perspective of functional modules in combination with the accompanying drawings. It should be understood that the functional modules may be implemented in the form of hardware, may be implemented by instructions in the form of software, or may be implemented by a combination of hardware and software modules. Specifically, each step of the method embodiments in the embodiments of the present disclosure may be completed by the hardware integrated logic circuit and/or software instructions in the processor. The steps of the method disclosed in the embodiments of the present disclosure may be directly reflected as being executed by a hardware decoding processor, or being executed by a combination of hardware and software modules in the decoding processor. Optionally, the software module may be located in a random memory, a flash memory, a read-only memory, a programmable read-only memory, an electrically erasable programmable memory, a register, and other storage media well established in the art. The storage medium is located in the memory, and a processor reads the information in the memory and completes the steps in the above method embodiments in combination with its hardware.

For example, the determining unit 410 or the determining unit 510 mentioned above may be implemented by a processor, and the receiving and sending unit 420 or the receiving and sending unit 520 mentioned above may be implemented by a transceiver.

FIG. 12 is a schematic structural diagram of a communication device 600 of the embodiments of the present disclosure.

As shown in FIG. 12, the communication device 600 may include a processor 610.

The processor 610 may call a computer program from a memory and run the computer program to implement the methods in the embodiments of the present disclosure.

As shown in FIG. 12, the communication device may further include a memory 620.

The memory 620 may be used to store indication information, and may also be used to store codes and instructions, etc., executed by the processor 610. The processor 610 may call a computer program from the memory 620 and run the computer program to implement the methods in the embodiments of the present disclosure. The memory 620 may be a separate means independent from the processor 610, or may be integrated into the processor 610.

As shown in FIG. 12, the communication device 600 may further include a transceiver 630.

The processor 610 may control the transceiver 630 to communicate with other devices, and specifically, may send information or data to other devices, or receive information or data transmitted from other devices. The transceiver 630 may include a transmitter and a receiver. The transceiver 630 may further include an antenna, and a number of the antenna(s) may be one or more.

It should be understood that the various components in the communication device 600 are connected by a bus system, where the bus system includes not only a data bus but also a power bus, a control bus and a state signal bus.

It should also be understood that the communication device 600 may be a terminal device of the embodiments of the present disclosure, and the communication device 600 may implement corresponding processes implemented by the terminal device in the various methods of the embodiments of the present disclosure. That is to say, the communication device 600 of the embodiments of the present disclosure may correspond to the terminal device 400 in the embodiments of the present disclosure, and may correspond to the corresponding subject in the method 200 that are executed according to the embodiments of the present disclosure, which will not be repeated herein for the sake of brevity. Similarly, the communication device 600 may be a network device in the embodiments of the present disclosure, and the communication device 600 may implement corresponding processes implemented by the network device in the various methods of the embodiments of the present disclosure. That is to say, the communication device 600 in the embodiments of the present disclosure may correspond to the network device 500 in the embodiments of the present disclosure, and may correspond to the corresponding subject in the method 300 that is executed according to the embodiments of the present disclosure, which will not be repeated herein for the sake of brevity.

In addition, the embodiments of the present disclosure further provide a chip.

For example, the chip may be an integrated circuit chip with a signal processing capability, and may implement or execute the methods, steps and logic block diagrams disclosed in the embodiments of the present disclosure. The chip may also be referred to as a system level chip, a system chip, a chip system, or a system-on-chip chip, etc. Optionally, the chip may be applied to various communication devices, so that the communication devices equipped with the chip can execute the methods, steps and logic block diagrams disclosed in the embodiments of the present disclosure.

FIG. 13 is a schematic structural diagram of a chip 700 according to the embodiments of the present disclosure.

As shown in FIG. 13, the chip 700 includes a processor 710.

The processor 710 may call a computer program from a memory and run the computer program to implement the methods in the embodiments of the present disclosure.

As shown in FIG. 13, the chip 700 may further include a memory 720.

The processor 710 may call a computer program from the memory 720 and run the computer program to implement the methods in the embodiments of the present disclosure. The memory 720 may be used to store indication information, and may also be used to store codes, instructions, etc., executed by the processor 710. The memory 720 may be a separate device independent from the processor 710, or may be integrated into the processor 710.

As shown in FIG. 13, the chip 700 may further include an input interface 730.

The processor 710 may control the input interface 730 to communicate with other devices or chips, and specifically, may obtain information or data transmitted from other devices or chips.

As shown in FIG. 13, the chip 700 may further include an output interface 740.

The processor 710 may control the output interface 740 to communicate with other devices or chips, and specifically, may output information or data to other devices or chips.

It should be understood that the chip 700 may be applied to the network device in the embodiments of the present disclosure, and the chip may implement the corresponding processes implemented by the network device in the various methods of the embodiments of the present disclosure, and may also implement the corresponding processes implemented by the terminal device in the various methods of the embodiments of the present disclosure, which will not be repeated herein for the sake of brevity.

It should also be understood that the various components in the chip 700 are connected by a bus system, where the bus system includes not only a data bus but also a power bus, a control bus and a status signal bus.

The processors mentioned above may include but are not limited to:
a general purpose processor, a digital signal processor (Digital Signal Processor, DSP), an application specific integrated circuit (Application Specific Integrated Circuit, ASIC), a field programmable gate array (Field Programmable Gate Array, FPGA) or other programmable logic devices, a discrete gate or transistor logic device, a discrete hardware component, etc.

The processor may be used to implement or execute the each method, step and logic block diagram disclosed in the embodiments of the present disclosure. The steps of the methods disclosed in the embodiments of the present disclosure may be directly implemented as being executed by a hardware decoding processor, or may be implemented by a combination of hardware and software modules in a decoding processor. The software module may be located in a random access memory, a flash memory, a read-only memory, a programmable read-only memory or an erasable programmable memory, a register, or other mature storage media in the art. The storage medium is located in the memory, and the processor reads the information in the memory and completes the steps of the above methods in combination with its hardware.

The memory mentioned above includes but is not limited to:
a volatile memory and/or a non-volatile memory. The non-volatile memory may be a read-only memory (Read-Only Memory, ROM), a programmable ROM (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which acts as an external cache memory. By way of example and not limitation, many forms of RAM are available, such as static RAM (Static RAM, SRAM), dynamic RAM (Dynamic RAM, DRAM), synchronous DRAM (Synchronous DRAM, SDRAM), double data rate SDRAM (Double Data Rate SDRAM, DDR SDRAM), enhanced SDRAM (Enhanced SDRAM, ESDRAM), synchronous link DRAM (synch link DRAM, SLDRAM), and direct RAMbus RAM (Direct Rambus RAM, DR RAM).

It should be noted that the memory described herein is intended to include these and any other suitable types of memory.

The embodiments of the present disclosure also provide a non-transitory computer-readable storage medium for storing a computer program. The non-transitory computer-readable storage medium stores one or more programs, the one or more programs include instructions that, when executed by a portable electronic device including multiple application programs, enable the portable electronic device to execute the information transmission method provided in the present disclosure. Optionally, the non-transitory computer-readable storage medium may be applied to the network device in the embodiments of the present disclosure, and the computer program enables the computer to execute the corresponding processes implemented by the network device in the various methods of the embodiments of the present disclosure. For the sake of brevity, they are not repeated here. Optionally, the non-transitory computer-readable storage medium may be applied to the mobile terminal/terminal device in the embodiments of the present disclosure, and the computer program enables the computer to execute the corresponding processes implemented by the mobile terminal/terminal device in the various methods of the embodiments of the present disclosure, which will not be repeated herein for the sake of brevity.

The embodiments of the present disclosure provide a computer program product. Optionally, the computer program product may be applied to the network device in the embodiments of the present disclosure, and the computer program enables the computer to execute the corresponding processes implemented by the network device in the various methods of the embodiments of the present disclosure. For the sake of brevity, they are not repeated here. Optionally, the computer program product may be applied to the mobile terminal/terminal device in the embodiments of the present disclosure, and the computer program enables the computer to execute the corresponding processes implemented by the mobile terminal/terminal device in the various methods of the embodiments of the present disclosure, which will not be repeated herein for the sake of brevity.

The embodiments of the present disclosure provide a computer program. When the computer program is executed by a computer, the computer may execute the information transmission method provided by the present disclosure. Optionally, the computer program may be applied to the network device in the embodiments of the present disclosure. When the computer program runs on a computer, the computer executes the corresponding processes implemented by the network device in the various methods in the embodiments of the present disclosure. For the sake of brevity, they are not described here. Optionally, the computer program may be applied to the mobile terminal/terminal device in the embodiments of the present disclosure. When the computer program runs on a computer, the computer executes the corresponding processes implemented by the mobile terminal/terminal device in the various methods of the embodiments of the present disclosure, which will not be repeated herein for the sake of brevity.

The embodiments of the present disclosure also provide a communication system, and the communication system may include the terminal device and network device involved above to form a communication system applicable to the solutions of the present disclosure. For the sake of brevity, it will not be described in detail here. It will be noted that the term “system” and the like herein may also be referred to as “network management architecture” or “network system”.

It should also be understood that the terms used in the embodiments of the present disclosure and the appended claims are for the purpose of describing specific embodiments only and are not intended to limit the embodiments of the present disclosure. For example, as used in the embodiments of the present disclosure and the appended claims, the singular forms “a,” “the,” “above,” and “the” are intended to include the plural forms as well, unless the context clearly indicates otherwise.

Those skilled in the art may realize that the present disclosure may be implemented in an electronic hardware or in a combination of the electronic hardware and a computer software with reference to units and algorithm steps of each example described in the embodiments disclosed herein. Whether these functions are performed by hardware or software depends on specific application and design constraints of the technical solutions. A skilled person may use different methods for each specific application to implement the described functions, but such implementation should not be considered beyond the scope of the present disclosure. If the integrated unit is implemented in the form of the software functional unit and sold or used as an independent product, it may be stored in a readable storage medium. Based on this understanding, the technical solutions of the present disclosure may be essentially, or a part of the technical solutions of the present disclosure that contributes to the related technology may be, embodied in the form of a software product, and the computer software product may be stored in a storage medium and includes a plurality of instructions to cause a computer device (which may be a personal computer, a server, or a network device, etc.) to perform all or part of the steps of the methods described in the embodiments of the present disclosure. And the aforementioned storage medium includes: a USB flash drive, a portable hard disk, a read-only memory (ROM), a random access memory (RAM), a disk or a CD ROM, and other kinds of mediums that may store program codes.

Those skilled in the art can clearly understand that for the convenience and simplicity of description, the working processes of the systems, devices and units described above may refer to the corresponding processes in the above method embodiments, and details will not be repeated here. In the embodiments provided by the present disclosure, it should be understood that the systems, devices and methods may be implemented in other ways. For example, the embodiments of the apparatus described above are merely exemplary. For example, a division of the units is only a logical functional division. In the actual implementation, there are another division manners. For example, multiple units or components may be combined or integrated into another system, or some features may be ignored or not executed. On the other hand, the mutual coupling or direct coupling or communication connection shown or discussed may be an indirect coupling or communication connection through some interfaces, devices or units, and may be in electrical, mechanical or other forms.

The foregoing descriptions are merely specific implementations of the present disclosure, but the protection scope of the present disclosure is not limited thereto. Any skilled person in the art could readily conceive of changes or replacements within the technical scope of the present disclosure, which shall all be included in the protection scope of the present disclosure. Therefore, the protection scope of the present disclosure shall be subject to the protection scope of the claims.

What is claimed is:

1. An information transmission method, wherein the method is applicable to a terminal device, and the method comprises:
determining, based on at least one piece of spatial information associated with at least one group of uplink information, at least one first transmission parameter set used by the at least one group of uplink information; and
sending, based on the at least one first transmission parameter set, the at least one group of uplink information to a network device.

2. The method according to claim 1, wherein each group of uplink information in the at least one group of uplink information comprises one or more pieces of uplink information, and the each group of uplink information in the at least one group of uplink information is associated with a same piece of spatial information in the at least one piece of spatial information.

3. The method according to claim 2, wherein the same piece of spatial information comprises at least one of: transmission configuration indication (TCI) state information, antenna panel information, transmission reception point (TRP) information, control resource set (CORESET) group information, reference signal set information, beam information, or capability set information.

4. The method according to claim 1, wherein the determining, based on the at least one piece of spatial information associated with the at least one group of uplink information, the at least one first transmission parameter set used by the at least one group of uplink information comprises:
determining at least one second transmission parameter set associated with the at least one piece of spatial information as the at least one first transmission parameter set;
wherein the second transmission parameter set comprises at least one of: an uplink transmission spatial filter of uplink information, power control parameter information of uplink information, beam information of uplink information, precoding information of uplink information, information of a number of transmission layers of uplink information, sounding reference signal (SRS) resource set information associated with uplink information, sounding reference signal resource indicator (SRI) information associated with uplink information, demodulation reference signal (DMRS) port information of uplink information, or transmission port information used by an SRS resource indicated by the SRI.

5. The method according to claim 1, wherein the determining, based on the at least one piece of spatial information associated with the at least one group of uplink information, the at least one first transmission parameter set used by the at least one group of uplink information comprises:
determining at least one second transmission parameter set associated with the at least one piece of spatial information; and
determining at least one third transmission parameter set associated with the at least one second transmission parameter set as the at least one first transmission parameter set.

6. The method according to claim 5, wherein the second transmission parameter set comprises sounding reference signal (SRS) resource set information;
the third transmission parameter set comprises at least one of: precoding information used by uplink information, information of a number of transmission layers used by uplink information, sounding reference signal resource indicator (SRI) information associated with uplink information, demodulation reference signal (DMRS) port information used by uplink information, or transmission port information used by uplink information.

7. The method according to claim 1, wherein the method further comprises:
determining a determining manner of the at least one first transmission parameter set;
wherein the determining manner of the at least one first transmission parameter comprises a first determining manner and a second determining manner, the first determining manner refers to determining the at least one first transmission parameter set based on at least one second transmission parameter set associated with the at least one piece of spatial information, and the second determining manner refers to determining the at least one first transmission parameter set based on a reference signal associated with a sounding reference signal (SRS) resource or an SRS resource set associated with the at least one group of uplink information.

8. The method according to claim 7, wherein the determining the determining manner of the at least one first transmission parameter set comprises:
determining the first determining manner or the second determining manner as the determining manner of the at least one first transmission parameter set; or
receiving second information sent from the network device, wherein the second information is used to indicate the determining manner of the at least one first transmission parameter set.

9. The method according to claim 1, wherein the at least one group of uplink information is scheduled by a same piece of downlink control information (DCI).

10. The method according to claim 1, wherein each spatial information of the at least one piece of spatial information comprises at least one of: transmission configuration indication (TCI) state information, antenna panel information, transmission reception point (TRP) information, control resource set (CORESET) group information, reference signal set information, beam information, or capability set information.

11. The method according to claim 1, wherein each group of uplink information in the at least one group of uplink information comprises at least one of: at least one physical uplink control channel (PUCCH), at least one physical uplink shared channel (PUSCH), a PUCCH corresponding to at least one transmission layer, a PUSCH corresponding to at least one transmission layer, a PUSCH corresponding to at least one redundant version (RV), at least one transmission block, at least one piece of uplink information transmitted in a frequency division multiplexing (FDM) transmission mode, at least one piece of uplink information transmitted in a spatial domain multiplexing (SDM) transmission mode, a PUSCH associated with at least one antenna panel, or a PUCCH associated with at least one antenna panel.

12. An information transmission method, wherein the method is applicable to a network device, and the method comprises:
determining, based on at least one piece of spatial information used by at least one group of uplink information, at least one first transmission parameter set used by the at least one group of uplink information; and
receiving, based on the at least one first transmission parameter set, the at least one group of uplink information sent from a terminal device.

13. The method according to claim 12, wherein each group of uplink information in the at least one group of uplink information comprises one or more pieces of uplink information, and the each group of uplink information in the at least one group of uplink information is associated with a same piece of spatial information in the at least one piece of spatial information;
wherein the same piece of spatial information comprises at least one of: transmission configuration indication (TCI) state information, antenna panel information, transmission reception point (TRP) information, control resource set (CORESET) group information, reference signal set information, beam information, or capability set information.

14. The method according to claim 12, wherein the determining, based on the at least one piece of spatial information associated with the at least one group of uplink information, the at least one first transmission parameter set used by the at least one group of uplink information, comprises:
determining at least one second transmission parameter set associated with the at least one piece of spatial information as the at least one first transmission parameter set;
wherein the second transmission parameter set comprises at least one of: an uplink transmission spatial filter of uplink information, power control parameter information of uplink information, beam information of uplink information, precoding information of uplink information, information of a number of transmission layers of uplink information, sounding reference signal (SRS) resource set information associated with uplink information, sounding reference signal resource indicator (SRI) information associated with uplink information, demodulation reference signal (DMRS) port information of uplink information, or transmission port information used by an SRS resource indicated by the SRI.

15. The method according to claim 12, wherein the determining, based on the at least one piece of spatial information associated with the at least one group of uplink information, the at least one first transmission parameter set used by the at least one group of uplink information comprises, comprises:
determining at least one second transmission parameter set associated with the at least one piece of spatial information; and
determining at least one third transmission parameter set associated with the at least one second transmission parameter set as the at least one first transmission parameter set;
wherein the second transmission parameter set comprises sounding reference signal (SRS) resource set information;
wherein the third transmission parameter set comprises at least one of: precoding information used by uplink information, information of a number of transmission layers used by uplink information, sounding reference signal resource indicator (SRI) information associated with uplink information, demodulation reference signal (DMRS) port information used by uplink information, or transmission port information used by uplink information.

16. The method according to claim 12, wherein the method further comprises:
determining a determining manner of the at least one first transmission parameter set;
wherein the determining manner of the at least one first transmission parameter comprises a first determining manner and a second determining manner, the first determining manner refers to determining the at least one first transmission parameter set based on the at least one second transmission parameter set associated with the at least one piece of spatial information, and the second determining manner refers to determining the at least one first transmission parameter set based on a reference signal associated with a sounding reference signal (SRS) resource or an SRS resource set associated with the at least one group of uplink information.

17. The method according to claim 16, wherein the determining the determining manner of the at least one first transmission parameter set comprises:
determining the first determining manner or the second determining manner as the determining manner of the at least one first transmission parameter set; or
sending second information to the terminal device, wherein the second information is used to indicate the determining manner of the at least one first transmission parameter set.

18. The method according to claim 12, wherein the at least one group of uplink information is scheduled by a same piece of downlink control information (DCI);
wherein each group of uplink information in the at least one group of uplink information comprises at least one of: at least one physical uplink control channel (PUCCH), at least one physical uplink shared channel (PUSCH), a PUCCH corresponding to at least one transmission layer, a PUSCH corresponding to at least one transmission layer, a PUSCH corresponding to at least one redundant version (RV), at least one transmission block, at least one piece of uplink information transmitted in a frequency division multiplexing (FDM) transmission mode, at least one piece of uplink information transmitted in a spatial domain multiplexing (SDM) transmission mode, a PUSCH associated with the at least one antenna panel, or a PUCCH associated with the at least one antenna panel.

19. The method according to claim 12, wherein each spatial information of the at least one piece of spatial information comprises at least one of: transmission configuration indication (TCI) state information, antenna panel information, transmission reception point (TRP) information, control resource set (CORESET) group information, reference signal set information, beam information, or capability set information.

20. A terminal device, comprising:
a processor and a memory, wherein the memory is configured to store a computer program, and the processor is configured to call and run the computer program stored in the memory, so as to enable the terminal device to perform:
determining, based on at least one piece of spatial information associated with at least one group of uplink information, at least one first transmission parameter set used by the at least one group of uplink information; and
sending, based on the at least one first transmission parameter set, the at least one group of uplink information to a network device.
